(19) United States
(12) Patent Application Publication
(10) Pub. No.: US 2025/0019257 A1
(43) Pub. Date: Jan. 16, 2025

(54) PRECURSOR OF LITHIUM-CONTAINING OXIDE CATHODE MATERIAL, LITHIUM-CONTAINING OXIDE CATHODE MATERIAL, PREPARATION METHODS THEREFOR AND USE THEREOF, AND POSITIVE ELECTRODE PLATE AND USE THEREOF

(71) Applicant: BEIJING EASPRING MATERIAL TECHNOLOGY CO., LTD., Beijing (CN)

(72) Inventors: Jun WANG, Beijing (CN); Yafei LIU, Beijing (CN); Yanbin CHEN, Beijing (CN)

(21) Appl. No.: 18/900,971

(22) Filed: Sep. 30, 2024

Related U.S. Application Data
(63) Continuation of application No. PCT/CN2022/120889, filed on Sep. 23, 2022.

(51) Int. Cl. C01G 45/12; H01M 10/0525

(52) U.S. Cl. CPC C01G 45/1228; H01M 10/0525; C01P 2002/74; C01P 2006/11; C01P 2006/40

(57) ABSTRACT

The present invention relates to the technical field of lithium-ion batteries, and discloses a precursor of a lithium-containing oxide cathode material, a lithium-containing oxide cathode material, a preparation method and use thereof, and a positive electrode plate and use thereof. The cathode material has a compressive index Δλ(P100) satisfying Δλ(P100)≥60%+(y/x)×5%, where y/x is a molar ratio of Mn/Ni in the cathode material. The lithium-containing oxide cathode material has high compressive strength and stability, only a small degree of fracture occurs under high pressure during a preparation process of the electrode plate, and it can be continuously subjected to lithium ion deintercalation/deintercalation reactions without serious rupture.

### CROSS-REFERENCE TO RELATED APPLICATIONS

This application is a continuation of International Application No. PCT/CN2022/120889, filed on Sep. 23, 2022, the disclosure of which is hereby incorporated by reference in entirety.

### FIELD

The present disclosure relates to the technical field of lithium-ion batteries, and more particularly, to a precursor of a lithium-containing oxide cathode material, a lithium-containing oxide cathode material, a preparation method and use thereof, and a positive electrode plate and use thereof.

### BACKGROUND

In recent years, new energy vehicles, as a strategic emerging industry to cope with environmental pollution and energy crisis, exhibit a tendency of booming development. Lithium-ion batteries, as new energy carriers with excellent comprehensive performance, are widely used in markets such as electric vehicles, energy storage power stations, communications, digital electronic products, and the like.

In a lithium-ion battery, a cathode serves as a core material and directly determines technical performance level of the battery. Among the commonly used cathode materials for lithium-ion batteries, LiNi_{1-x-y}CoₓMn_{y}O₂(NCM) and LiNi_{1-x-y}CoₓAl_{y}O₂(NCA) with layered structure and lithium-rich manganese-based materials (LMR) have attracted much attention and are adequately studied due to their high specific capacity and energy density. However, in order to obtain higher volume energy density and comprehensive electrochemical performance, the cathode material has to be rolled with high pressure during a preparation process of an electrode plate to obtain a high electrode density. The cathode materials with low strength may be fractured or crushed in this process, which may increase contact area and side reactions with the electrolyte, thereby resulting in deterioration in cycle performance and rate performance. In addition, during the use of battery, repeated Li⁺ deintercalation may cause expansion or contraction of a volume of the layered structure, which may lead to pulverization of the low-strength cathode material, thereby resulting in insufficient contact between particles, continuous formation of new electrolyte layers and increased side reactions, and thereby deterioration and even failure of battery performance.

Therefore, it is of great significance to develop a new preparation method, to adjust microstructure of the cathode materials with the layered structure, and to enhance the compressive strength or particle strength of the cathode materials, for achieving long cycle life, high specific capacity, and high rate performance of batteries.

### SUMMARY

In a first aspect, the present disclosure provides a lithium-containing oxide cathode material. The cathode material has a compressive index Δλ(P₁₀₀) satisfying Δλ(P₁₀₀)≥60%+(y/x)×5%, where y/x is a molar ratio of Mn/Ni in the cathode material.

In a second aspect, the present disclosure provides a precursor of a lithium-containing oxide cathode material. The precursor has a compressive index Δλ′(P₅₀) satisfying Δλ′(P₅₀)≥35%+(v/u)×8%, where v/u is a molar ratio of Mn/Ni in the precursor.

In third aspect, the present disclosure provides a preparation method of a lithium-containing oxide cathode material. The preparation method includes: S1, uniformly mixing a precursor having a chemical formula represented by Formula (1), a lithium source, and an optional additive containing element M₂, and performing a first sintering in an atmosphere furnace, to obtain a primary sintered material having a chemical formula represented by Formula (2); and S2: uniformly mixing the primary sintered material with an additive containing element M′, and performing a second sintering on the mixed material in an atmosphere furnace, to obtain a lithium-containing metal oxide having a chemical formula represented by Formula (3),

NiᵤMnᵥM_{1γ}(OH)₂, Formula (1),

where: u+v+γ=1, 0.2<u<1, 0<v≤0.75, 0≤γ≤0.35, and M₁ is selected from at least one element of Al, Zr, Nb, Ti, Y, Sc, Cr, Co, W, Mg, Na, La, Os, Pr, Re, Ru, Sr, Sm, Ta, and B;

Li[LiₐNiₓMn_{y}Mⱼ]O₂, Formula (2);

Li[LiₐNiₓMn_{y}Mⱼ]O₂@M′, Formula (3);

wherein in Formula (2) and Formula (3), a+x+y+j=1, 0≤a≤0.3, 0.2<x<1, 0<y≤0.75, 0<j≤0.35; and M includes element M₁ in the precursor and element M₂ introduced during the first sintering, M₁ and M₂ being the same or different and being each selected from at least one element of Al, Zr, Nb, Ti, Y, Sc, Cr, Co, W, Mg, La, Os, Pr, Re, Ru, Sr, Sm, Ta, and B; and wherein in Formula (3), M′ is oxide, phosphide, sulfide, fluoride, or chloride containing at least one element of Al, Zr, Nb, Ti, Y, Sc, Cr, Co, W, Mg, La, Os, Pr, Re, Ru, Sr, Sm, Ta, and B, and a molar content of cations in M′is w, w satisfying 0<w/(a+x+y+j)≤0.1.

In a fourth aspect, the present disclosure provides a lithium-containing oxide cathode material prepared by the above-mentioned preparation method of the lithium-containing oxide cathode material.

In a fifth aspect, the present disclosure provides a positive electrode plate. The positive electrode plate includes at least 90 wt % of a lithium-containing oxide cathode material based on a total weight of the positive electrode plate. The lithium-containing oxide cathode material is the lithium-containing oxide cathode material according to the first aspect.

In a sixth aspect, the present disclosure provides a lithium-ion battery. The lithium-ion battery includes the above-mentioned positive electrode plate according to the second aspect, a negative electrode plate, a separator, and an electrolyte.

### BRIEF DESCRIPTION OF THE DRAWINGS

FIG. 1 is a schematic comparison graph of charge-discharge curves of Example 5 and Comparative Example 1;

FIG. 2 is a schematic comparison graph of cycle performance of Example 5 and Comparative Example 1;

FIG. 3 is a schematic comparison graph of charge-discharge curves of Example 5 and Comparative Example 2;

FIG. 4 is a schematic comparison graph of cycle performance of Example 5 and Comparative Example 2;

FIG. 5 is a schematic comparison graph of charge-discharge curves of Example 5 and Comparative Example 3;

FIG. 6 is a schematic comparison graph of cycle performance of Example 5 and Comparative Example 3;

FIG. 7 is a schematic comparison graph of charge-discharge curves of Example 5 and Comparative Example 4;

FIG. 8 is a schematic comparison graph of cycle performance of Example 5 and Comparative Example 4;

FIG. 9 is a schematic comparison graph of charge-discharge curves of Example 9 and Comparative Example 5;

FIG. 10 is a schematic comparison graph of cycle performance of Example 9 and Comparative Example 5;

FIG. 11 is a schematic comparison graph of charge-discharge curves of Example 9 and Comparative Example 6;

FIG. 12 is a schematic comparison graph of cycle performance of Example 9 and Comparative Example 6;

FIG. 13 is a schematic comparison graph of charge-discharge curves of Example 9 and Comparative Example 7; and

FIG. 14 is a schematic comparison graph of cycle performance of Example 9 and Comparative Example 7.

### DETAILED DESCRIPTION

In the present disclosure, endpoints and any value of the ranges shall not be limited to the exact range or value, and those ranges or values should be understood to include values close to those ranges or values. For numerical ranges, endpoints of respective ranges, an endpoint and individual point value of respective ranges, and individual point values can be combined with each other to obtain one or more new numerical ranges, which should be deemed to be specifically disclosed herein.

The conventional lithium-ion batteries using lithium-containing metal oxide material have to withstand high pressure during the preparation process of electrode plates. In addition, during continuous charge and discharge cycles, the material may rupture due to its insufficient compressive strength or unstable structure, thereby increasing side reactions with the electrolyte. Thus, the consumption of the electrolyte and the dissolution of transition metal cations in the cathode material are accelerated, resulting in reduced cycle performance, safety performance, and capacity, and even battery failure.

An object of the present disclosure is to overcome the defects in the prior art that lithium-containing metal oxide materials may rupture during a preparation process of an electrode plate, or secondary particles may rupture during a charge and discharge cycle, resulting in poor rate performance, deterioration of cycle performance, and reduced safety performance. Provided are a precursor of a lithium-containing oxide cathode material, a lithium-containing oxide cathode material, a preparation method and use thereof, and a positive electrode plate and use thereof. The lithium-containing oxide cathode material has high compressive strength and stability, only a small degree of fracture occurs under high pressure during a preparation process of the electrode plate, and it can be continuously subjected to lithium ion deintercalation/deintercalation reactions without serious rupture.

As mentioned above, a first aspect of the present disclosure provides a lithium-containing oxide cathode material. The cathode material has a compressive index Δλ(P₁₀₀) satisfying Δλ(P₁₀₀)≥60%+(y/x)×5%, where y/x is a molar ratio of Mn/Ni in the cathode material.

In addition, in the present disclosure:

$$Δλ ( {P}_{n} ) = ( 1 - \frac{{D}_{5}^{0} - {D}_{5}^{pn}}{{D}_{5}^{0}} ) \times 100 \% , where :$$

D₅⁰ refers to a value of particle cumulative distribution D₅ of the material in a natural state without external mechanical pressure (i.e., P=0 Mpa); D₅^{pn} refers to a value of particle cumulative distribution D₅ of the material under P=n Mpa; and D₅ refers to a particle size value when a cumulative volume distribution of the particles is 5%.

For example, the compressive index Δλ(P₁₀₀) is calculated based on the following equation:

$$Δλ ( {P}_{100} ) = ( 1 - \frac{{D}_{5}^{0} - {D}_{5}^{P 100}}{{D}_{5}^{0}} ) \times 100 \% .$$

According to the present disclosure, preferably, the cathode material has a compressive index Δλ(P₂₀₀) satisfying Δλ(P₂₀₀)≥45%+(y/x)×5%.

According to the present disclosure, more preferably, the cathode material has a compressive index Δλ(P₃₀₀) satisfying Δλ(P₃₀₀)≥35%+(y/x)×5%.

According to the present disclosure, it should be noted that Δλ(P₁₀₀) represents the compressive index of the material when pressure P=100 Mpa; Δλ(P₂₀₀) represents the compressive index of the material when pressure P=200 Mpa; and so on. The cathode material according to the present disclosure has excellent compressive

strength and is not prone to rupture. When the cathode material according to the present disclosure is used as a cathode, it has a stable structure, few side reactions, and excellent safety performance and capacity retention rate.

According to the present disclosure, the lithium-containing oxide cathode material has a chemical formula represented by Formula (3):

Li[LiₐNiₓMn_{y}Mⱼ]O₂@M′, Formula (3), where:

a+x+y+j=1; 0<a≤0.3; 0.2<x<1; 0<y≤0.75; 0<j≤0.35; M is selected from at least one element of Al, Zr, Nb, Ti, Y, Sc, Cr, Co, W, Mg, La, Os, Pr, Re, Ru, Sr, Sm, Ta, and B; M′ is oxide, phosphide, sulfide, fluoride, or chloride containing at least one element of Al, Zr, Nb, Ti, Y, Sc, Cr, Co, W, Mg, La, Os, Pr, Re, Ru, Sr, Sm, Ta, and B; and a molar content of cations in M′ is w, w satisfying 0<w/(a+x+y+j)≤0.1.

According to the present disclosure, preferably, 0.02≤a≤0.3; 0.3<x<0.9; 0.05<y≤0.68; 0<j≤0.3; and 0.001<w/(a+x+y+j)≤0.02.

According to the present disclosure, M is selected from at least one element of Zr, Nb, Ti, Y, Sc, Cr, Co, W, Mg, La, Ta, and B; and M′ is oxide, phosphide, sulfide, or fluoride containing at least one element of Zr, Nb, Ti, Y, Sc, Cr, Co, W, Mg, La, Ta, and B.

In the present disclosure, the inventors found that: by adopting an appropriate modifier, the compressive strength and stability of material particles can be enhanced, a value of direct current internal resistance and gas production of the material during the cycle can be reduced, and the cycle life of the material can be prolonged.

By doping with elements such as Ti, Sc, Zr, W, Mg, Y, Co, Cr, Ta, and the like, crystal structure of the material can be stabilized, micro-area structure of the material can be improved, and the compressive index, cycle life, and safety performance of the material can be improved. By doping with elements such as Ti, Zr, Nb, La, W, Co, B, and the like, lithium-containing compounds (such as LiNbO₃, Li₂ZrO₃, Li₄TisO₁₂, Li₃BO₃, or LaNiO₃, etc.) may be formed on the surface of the material particles or at the interface between the particles, thereby stabilizing the surface structure of the material particles or the interface strength between the particles or the grain boundary structure between the primary crystal grains, and the compressive index and cycle life of the material can be improved. Furthermore, transmission of lithium-ions between the particles and between the interfaces can be accelerated, and rate performance of the material can be improved. The cathode material according to the present disclosure also has other characteristics.

According to the present disclosure, the cathode material has a tap density of ≥1.7 g/cm³, preferably ≥2 g/cm³, and more preferably ≥2.4 g/cm³.

According to the present disclosure, the cathode material has a pellet density of ≥2.8 g/cm³, preferably ≥3 g/cm³, and more preferably ≥3.2 g/cm³.

According to the present disclosure, a content of surface soluble alkali of the cathode material satisfies the following conditions: Li₂CO₃≤1 wt %, LiOH≤0.5 wt %; preferably, Li₂CO₃≤0.5 wt %, LiOH≤0.4 wt %; further preferably, Li₂CO₃≤0.3 wt %, LiOH≤0.3 wt %; and more preferably, Li₂CO₃≤0.2 wt %, LiOH≤0.2 wt %.

According to the present disclosure, a full width at half maximum FWHM₍₀₀₃₎ of (003) crystal plane and a full width at half maximum FWHM₍₁₀₄₎ of (104) crystal plane of the cathode material obtained by X-Ray Diffraction (XRD) satisfy the following conditions: 0.10≤FWHM₍₀₀₃₎≤0.25, and preferably, 0.13≤FWHM₍₀₀₃₎≤0.22; and 0.20≤FWHM₍₁₀₄₎≤0.50, and preferably, 0.22≤FWHM₍₁₀₄₎≤0.42.

According to the present disclosure, a peak area S₍₀₀₃₎ of the (003) crystal plane and a peak area S₍₁₀₄₎ of the (104) crystal plane of the cathode material obtained by XRD satisfy the following conditions: 1.1≤S₍₀₀₃₎/S₍₁₀₄₎≤1.8, and preferably, 1.2≤S₍₀₀₃₎/S₍₁₀₄₎≤1.6.

In addition to using suitable additives, the present disclosure also achieves high crystallinity and compactness of the precursor by controlling the morphology and microstructure of the precursor, thereby increasing the compressive index of the cathode material.

A second aspect of the present disclosure provides a precursor of a lithium-containing oxide cathode material. The precursor has a compressive index Δλ′(P₅₀) satisfying Δλ′(P₅₀)≥35%+(v/u)×8%, where v/u is a molar ratio of Mn/Ni in the precursor.

According to the present disclosure, preferably, the precursor has a compressive index Δλ′(P₁₀₀) satisfying Δλ′(P₁₀₀)≥25%+(v/u)×8%.

According to the present disclosure, it should be noted that Δλ′(P₅₀) represents the compressive index of the precursor material when pressure P=50 MPa; Δλ′(P₁₀₀) represents the compressive index of the precursor material when pressure P=100 MPa; and so on.

In the present disclosure,

$${Δλ}^{′} ( {P}_{n} ) = ( 1 - \frac{{D}_{5}^{′0} - {D}_{5}^{′ Pn}}{{D}_{5}^{′0}} ) \times 100 \% , where :$$

D′₅⁰ refers to a value of particle cumulative distribution D₅ of the material in a natural state without external mechanical pressure (i.e. P=0 Mpa); D′₅^{Pn} refers to a value of particle cumulative distribution D₅ of the material under P=n Mpa.

For example, the compressive index Δλ′(P₅₀) of the precursor is calculated as follows:

$${Δλ}^{′} ( {P}_{50} ) = ( 1 - \frac{{D}_{5}^{′0} - {D}_{5}^{′ P 50}}{{D}_{5}^{′0}} ) \times 100 \% .$$

According to the present disclosure, the precursor has a chemical formula represented by Formula (1):

NiᵤMnᵥM_{γ}(OH)₂, Formula (1), where:
u+v+γ=1, 0.2<u<1, 0<v≤0.75, 0≤γ≤0.35, and M is selected from at least one element of Al, Zr, Nb, Ti, Y, Sc, Cr, Co, W, Mg, Na, La, Os, Pr, Re, Ru, Sr, Sm, Ta, and B; and
preferably, 0.3≤u≤0.9, 0.05≤v≤0.68, 0≤γ≤0.3, and M is selected from at least one element of Ti, Al, Zr, W, Co, Nb, La, Na, and Mg.

In the present disclosure, by doping with elements such as Ti, Al, Zr, W, Co, Nb, La, Na, and Mg, micro-area interior or surface structure of the precursor can be stabilized.

The precursor material according to the present disclosure is also characterized in the following aspects.

According to the present disclosure, more preferably, the precursor has a tap density of ≥1.2 g/cm³, preferably ≥1.6 g/cm³, and further preferably ≥2 g/cm³.

According to the present disclosure, the precursor has a specific surface area BET value satisfying BET≤30 m²/g, and preferably, BET≤25 m²/g.

According to the present disclosure, the precursor has a particle size distribution coefficient K₉₀ satisfying 0.5≤K₉₀≤1.6, where K₉₀=(D₉₀−D₁₀)/D₅₀, and D₁₀, D₅₀, and D₉₀ refer to the particle size values when the cumulative volume distribution of the particles is 10%, 50%, and 90%, respectively.

According to the present disclosure, a full width at half maximum FWHM₍₀₀₁₎ of (001) crystal plane, a full width at half maximum FWHM₍₁₀₀₎ of (100) crystal plane, and a full width at half maximum FWHM₍₁₀₁₎ of (101) crystal plane of the precursor obtained by XRD satisfy the following conditions:
0.3≤FWHM₍₀₀₁₎≤1, and preferably, 0.5≤FWHM₍₀₀₁₎≤0.8, i.e., 2θ, measured by an X-ray diffractometer, of FWHM₍₀₀₁₎ of the precursor material according to the present disclosure is not less than 0.3 and not greater than 1, and preferably, not less than 0.5 and not greater than 0.8;
0.10≤FWHM₍₁₀₀₎≤0.5, and preferably, 0.25≤FWHM₍₁₀₀₎≤0.35; and
0.30≤FWHM₍₁₀₁₎≤1.0, and preferably, 0.4≤FWHM₍₁₀₁₎≤0.8.

According to the present disclosure, a peak area S₍₁₀₁₎ of the (001) crystal plane and a peak area S₍₁₀₄₎ of the (101) crystal plane of the precursor obtained by XRD satisfy the following condition: S₍₀₀₁₎/S₍₁₀₁₎≥2.0.

According to the present disclosure, an integral area S₍₁₀₁₎ of the (001) crystal plane and an integral area S₍₁₀₄₎ of the (101) crystal plane of the precursor obtained by XRD satisfy the following condition: S₍₀₀₁₎/S₍₁₀₁₎≥2.0.

The present disclosure further provides a preparation method of a precursor of a lithium-containing oxide cathode material. The preparation method includes: (1) mixing, by contacting, a solution or suspension of a nickel salt, a manganese salt, and a compound containing M, to obtain a mixed salt solution; and (2) feeding the parallel flows of the mixed salt solution, a precipitant solution, and a complexing agent solution 1 into a reactor for crystallization reaction, and performing solid-liquid separation, washing, heat treatment, and sieving treatment on the obtained slurry, to obtain the precursor of the lithium-containing oxide cathode material.

In the present disclosure, the inventors found that: for metal hydroxide precursors, during the mixing and sintering process, the precursor may rupture due to its insufficient compressive strength, resulting in reduced compressive strength, reduced tap density, and reduced electrochemical performance of the prepared cathode material. In the present disclosure, by controlling the synthesis process of the precursor, such as a concentration and type of the complexing agent, a concentration of the precipitant, stirring intensity, a reaction temperature, additives, a solid content, and a feed rate, a precursor with high crystallinity and compactness can be synthesized. By adjusting the particle size distribution and specific surface area of the precursor, the crystallinity, tap density, and compressive index of the precursor material can be improved. In addition, by adding suitable additives and adjusting the microstructure and morphology of the precursor, the compressive index of the precursor can be improved.

According to the present disclosure, the nickel salt, the manganese salt, or the additive containing M element are dissolved according to a molar ratio of u:v:γ to form a mixed salt solution with a concentration ranging from 1 mol/L to 3 mol/L. The compound containing M is added into water to prepare an M solution or suspension with a certain concentration. The alkali solution with a concentration ranging from 2 mol/L to 10 mol/L is obtained by dissolving alkali. The complexing agent solution with a concentration ranging from 2 mol/L to 13 mol/L is obtained by dissolving a complexing agent.

According to the present disclosure, the slurry has a solid content ranging from 200 g/L to 1000 g/L, and preferably, from 300 g/L to 800 g/L.

According to the present disclosure, the mixed salt solution of Ni and Mn, the alkali solution, the complexing agent solution, and the M solution are respectively added to a reactor having an overflow pipe through respective liquid inlet pipes in parallel flows, the stirring speed is kept constant, and inlet flow rates of the mixed salt solution, the precipitant solution, the complexing agent solution, and the M solution are controlled.

According to the present disclosure, the reaction conditions include: a reaction temperature ranging from 40° C. to 70° C., reaction pH ranging from 10.6 to 12.5, and a reaction duration ranging from 5 hours to 100 hours.

According to the present disclosure, the nickel salt is one or more of nickel sulfate, nickel chloride, nickel nitrate, and nickel acetate.

According to the present disclosure, the manganese salt is one or more of manganese sulfate, manganese chloride, manganese nitrate, and manganese acetate.

According to the present disclosure, the compound containing M is one or more of sulfate, chloride, nitrate, acetate, citrate, carbonate, phosphate, oxalate, and fluoride containing the element M.

According to the present disclosure, the precipitant is an alkaline substance, and the alkali is one or more of sodium hydroxide, potassium hydroxide, and lithium hydroxide.

According to the present disclosure, the complexing agent is one or more of salicylic acid, ammonium sulfate, ammonium chloride, ammonium hydroxide, sulfosalicylic acid, and ethylenediaminetetraacetic acid.

According to the present disclosure, the sintering system (including sintering temperature, heating rate, sintering atmosphere, etc.) during the preparation of the lithium-containing metal oxide is also very important and will affect the compressive index of the material.

A third aspect of the present disclosure provides a preparation method of a lithium-containing oxide cathode material. The preparation method includes:
S1, uniformly mixing a precursor having a chemical formula represented by Formula (1), a lithium source, and an optional additive containing element M₂, and performing a first sintering on the mixed material in an atmosphere furnace, to obtain a primary sintered material having a chemical formula represented by Formula (2); and
S2, uniformly mixing the primary sintered material with an additive containing element M′, and performing a second sintering on the mixed material in an atmosphere furnace, to obtain a lithium-containing metal oxide having a chemical formula represented by Formula (3),

NiᵤMnᵥM_{1γ}(OH)₂, Formula (1),

where: u+v+γ=1, 0.2<u<1, 0<v≤0.75, 0≤γ≤0.35, and M₁ is selected from at least one element of Al, Zr, Nb, Ti, Y, Sc, Cr, Co, W, Mg, Na, La, Os, Pr, Re, Ru, Sr, Sm, Ta, and B;

Li[LiₐNiₓMn_{y}Mⱼ]O₂, Formula (2);

Li[LiₐNiₓMn_{y}Mⱼ]O₂@M′, Formula (3);

wherein in Formula (2) and Formula (3), 0≤a≤0.3, 0.2<x<1, 0<y≤0.75, 0<j≤0.35; and M includes element M₁ in the precursor and element M₂ introduced during the first sintering, M₁ and M₂ being the same or different and being each selected from at least one element of Al, Zr, Nb, Ti, Y, Sc, Cr, Co, W, Mg, La, Os, Pr, Re, Ru, Sr, Sm, Ta, and B; and wherein in Formula (3), M′is oxide, phosphide, sulfide, fluoride, or chloride containing at least one element of Al, Zr, Nb, Ti, Y, Sc, Cr, Co, W, Mg, La, Os, Pr, Re, Ru, Sr, Sm, Ta, and B, and a molar content of cations in M′ is w, w satisfying 0<w/(a+x+y+j)≤0.1.

According to the present disclosure, the source of the element M in the cathode material includes the element M₁ in the precursor and the additive containing the element M₂ introduced during the first sintering process.

According to the present disclosure, the lithium source is at least one of lithium hydroxide, lithium carbonate, and lithium nitrate;

According to the present disclosure, the additive containing the element M₂ is selected from at least one of oxide, hydroxide, oxyhydroxide, phosphate, fluoride, boride, and carbonate containing the element M₂.

According to the present disclosure, the element M₁ and the element M₂ are the same as or different from the element M, and are each selected from at least one element of Al, Zr, Nb, Ti, Y, Sc, Cr, Co, W, Mg, La, Os, Pr, Re, Ru, Sr, Sm, Ta, and B.

According to the present disclosure, the additive containing the element M′ is selected from at least one of oxide, hydroxide, oxyhydroxide, phosphate, fluoride, boride, nitride, carbonate, and oxalate containing the element M′.

According to the present disclosure, a molar ratio Li/(Ni+Mn+M₁+M₂) of the lithium source to a sum of the precursor and the additive containing the element M₂ ranges from 1 to 1.85, and preferably from 1 to 1.5.

According to the present disclosure, the additive containing the element M₂ is added according to M₂/(Ni+Mn+M₁+M₂) ranging from 0.0005 to 0.3, and preferably, from 0.001 to 0.2.

According to the present disclosure, a molar ratio M′/(Ni+Mn+M₁+M₂) of the additive containing the element M′ to the primary sintered material ranges from 0 to 0.1, and preferably, from 0.001 to 0.02.

According to the present disclosure, when a molar ratio of Ni/Mn is greater than 1,that is, x/y>1, a relationship between a sintering temperature T₁ of the first sintering and a content of Ni satisfies 550×(2−x)° C.≤T₁≤400×(3−x)° C., and a sintering duration of the first sintering ranges from 6 hours to 20 hours, and preferably, from 8 hours to 15 hours.

According to the present disclosure, when the molar ratio of Ni/Mn is smaller than or equal to 1, that is, y/x≥1, a relationship between a sintering temperature T₂ of the first sintering and a content of Mn satisfies 500×(1+y)≤T₂≤650×(1+y)° C., and a sintering duration of the first sintering ranges from 6 hours to 20 hours, and preferably, from 8 hours to 15 hours.

According to the present disclosure, when x<0.5, the first sintering and the second sintering are performed in an air atmosphere; when 0.5≤x<0.6, the first sintering and the second sintering are performed in an air atmosphere or a mixture atmosphere of air and oxygen; and when x≥0.6, the first sintering and the second sintering are performed in an oxygen atmosphere or a mixture atmosphere of oxygen and air.

A fourth aspect of the present disclosure provides a lithium-containing oxide cathode material prepared by the above-mentioned preparation method of the lithium-containing oxide cathode material.

A fifth aspect of the present disclosure provides a positive electrode plate. The positive electrode plate includes at least 90 wt % of a lithium-containing oxide cathode material based on a total weight of the positive electrode plate. The lithium-containing oxide cathode material is the above-mentioned lithium-containing oxide cathode material.

According to the present disclosure, preferably, a mass percentage of the cathode material is not less than 95%.

According to the present disclosure, the positive electrode plate has an electrode density of ≥2.8 g/cm³, preferably ≥3.2 g/cm³, and more preferably ≥3.5 g/cm³.

A sixth aspect of the present disclosure provides use of the above-mentioned lithium-containing oxide cathode material, the above-mentioned precursor of the lithium-containing oxide cathode material, or the above-mentioned positive electrode plate in a lithium-ion battery.

Based on the above-mentioned technical solutions, the present disclosure has the following advantages.
(1) For the lithium-containing oxide cathode material and the precursor thereof according to the present disclosure, high crystallinity and compactness of the precursor can be achieved by controlling a specific microstructure, thereby improving the compressive index of the cathode material.
(2) The present disclosure can improve the compressive index, cycle life, and safety performance of the material by means of appropriate modifiers and doping elements.
(3) In the preparation process of the lithium-containing metal oxide according to the present disclosure, the sintering system affects the compressive index of the material. Therefore, when selecting the sintering system, cost and the compressive index, physical indicators, and electrochemical performance of the material can also be taken into consideration.

The present disclosure will be described in detail below by way of examples.

In the following examples and comparative examples, all raw materials are commercially available, unless otherwise specified.

In the following examples, the involved performances were obtained by the following ways.
(1) Phase test: test by means of a SmartLab 9 kW X-ray diffractometer from Rigaku Corporation, Japan.
(2) Morphology test: test by means of S-4800 scanning electron microscope from Hitachi, Ltd, Japan.
(3) Particle size test: test by means of Hydro 2000 mu laser particle size analyzer from Marvern, Inc.
(4) Specific surface area: obtained by means of Tristar II 3020 specific surface area tester from Micromertics, USA.
(5) Tap density: obtained by means of BT-30 tap density tester from Baxter Company.
(6) Pellet density: obtained by means of MCP-PD51 powder impedance tester from Mitsubishi Chemical Corporation, Japan.
(7) Compressive index test: the material was compressed under a specific pressure by means of 4350 manual tablet press from Carver Company, USA, and the particle size of the fractured material was measured and calculated based on the equation of compressive index.
(8) Surface residual alkali test: measured by titration using Metrohmm888 professional Tirando intelligent potentiometric titrator.
(9) Thermal stability test: by using TGA-DSC3 thermogravimetric analyzer from Mettler Toledo.
(10) Electrochemical performance test:

The electrochemical performance of the prepared lithium-containing oxide cathode material was obtained by testing 2025-type button batteries using Xinwei Battery Test System. Specifically:

### 1) The Preparation Process of a 2025-Type Button Battery

Preparation of electrode plate: a lithium-containing oxide cathode material, carbon black, and polyvinylidene fluoride according to a certain mass ratio were fully mixed with an appropriate amount of N-methylpyrrolidone to prepare a uniform slurry, and the slurry was coated on an aluminum foil, dried at 120° C., rolled, and punched to form a positive electrode plate with a diameter of 11 mm.

Assembly of battery: a Li metal plate with a diameter of 17 mm and a thickness of 1 mm was used as a negative electrode; a polyethylene porous membrane with a thickness of 25 μm was used as a separator; and a mixture of equal amounts of 1 mol/L LiPF₆, ethylene carbonate (EC), and diethyl carbonate (DEC) was used as an electrolyte.

The positive electrode plate, the separator, the negative electrode plate, and the electrolyte were assembled into a 2025-type button battery in an Ar glove box with a water content and an oxygen content of less than 5 ppm, and the battery at this moment was regarded as an unactivated battery.

### 2) Electrochemical Performance Test

When a molar ratio of Ni/Mn was greater than 1, i.e., x/y>1, the test conditions of the button battery were as follows. The button battery, after being prepared, was placed for 2 hours. After the open circuit voltage was stabilized, the battery was charged to a cut-off voltage of 4.3V with a current density of 0.1 C at the cathode, next charged at a constant voltage for 30 minutes, and then discharged to a cut-off voltage of 3.0V at a same current density. The same method was repeated once, and the battery at this moment was regarded as an activated battery. Under a voltage ranging from 3.0V to 4.3V and within a charge and discharge range from 3.0V to 4.3V, the activated battery was subjected to charge and discharge tests at 25° C. and at 0.1 C to evaluate the charge and discharge capacity of the material. The activated battery was subjected to charge and discharge tests at 0.1 C, 0.2 C, 0.33 C, 0.5 C, and 1 C, and a ratio of 1 C capacity to 0.1 C capacity was used to evaluate the rate performance of the material. In the range from 3.0V to 4.4V, the cycle performance of the material after 80 cycles at 1 C was evaluated.

When the molar ratio of Ni/Mn is not greater than 1, that is, x/y≤1, the test conditions of the button battery were as follows. The button battery, after being prepared, was placed for 2 hours. After the open circuit voltage was stabilized, the battery was charged to a cut-off voltage of 4.6V with a current density of 0.1 C at the cathode, next charged at a constant voltage for 30 minutes, and then discharged to a cut-off voltage of 2.0V at a same current density. The same method was repeated once, and the battery at this moment was regarded as an activated battery. Under a voltage ranging from 2.0V to 4.6V and within a charge and discharge range from 2.0V to 4.6V, the activated battery was subjected to charge and discharge tests at 25° Cand at 0.1 C to evaluate the charge and discharge capacity of the material. The activated battery was subjected to charge and discharge tests at 0.1 C, 0.2 C, 0.33 C, 0.5 C, and 1 C, and a ratio of 1C capacity to 0.1 C capacity was used to evaluate the rate performance of the material. In the range from 2.0V to 4.6V, the cycle performance of the material after 80 cycles at 0.5 C was evaluated.

### EXAMPLE 1

Example 1 was intended to illustrate a lithium-containing oxide cathode material prepared according to the present disclosure.

Nickel sulfate and manganese sulfate were dissolved according to a metal molar ratio of 5:3 to obtain a 2 mol/L mixed salt solution. Cobalt sulfate and aluminum sulfate were dissolved according to metal molar ratios of Co/(Ni+Mn+Co+Al)=0.18 and Al/(Ni+Mn+Co+Al)=0.02 to obtain a 2 mol/L mixed salt solution. Sodium hydroxide was dissolved to form an alkaline solution with a concentration of 6 mol/L, and ammonium hydroxide was dissolved to form a complexing agent solution with a concentration of 5 mol/L.

Then, 20 L of mixed salt solution, alkaline solution, and complexing agent solution were added into a reactor in parallel for reaction. The stirring speed was kept constant at 600 rpm during the process. In the meantime, an inlet flow rate of the mixed salt solution was controlled to 300 mL/h, reaction pH was controlled to 11.6, reaction temperature was kept at 50° C., and a concentration of ammonia in the reaction system was controlled to be 9 g/L. The reaction was carried out in N₂ gas, and the reaction was stayed for 60 hours. The solid content was 500 g/L. The slurry obtained through crystallization reaction of the precipitate was subjected to solid-liquid separation and washing, and then dried at 105° C. for 10 hours. A spherical Ni_{0.5}Mn_{0.3}Co_{0.18}Al_{0.02}(OH)₂ precursor material was obtained after sieving, which was recorded as P-1.

The precursor P-1, lithium carbonate, and additives TiO₂ and WO₃ were mixed evenly in a high-speed mixer according to Li:(Ni+Mn+Co+Al+Ti+W)=1.03, Ti:(Ni+Mn+Co+Al+Ti+W)=0.003, W:(Ni+Mn+Co+Al+Ti+W)=0.002. In an air atmosphere, the temperature was raised to 920° C., maintained for 10 hours, and naturally cooled, to obtain a primary sintered cathode material Li[Li₀Ni_{0.4975}Mn_{0.2985}Co_{0.1791}Al_{0.0199}Ti_{0.003}W_{0.002}]O₂, which was recorded as S-1.

The primary sintered material S-1, and additives Nb₂O₅ and La₂O₃ were mixed evenly according to Nb:(Ni+Mn+Co+Al+Ti+W)=0.002 and La:(Ni+Mn+Co+Al+Ti+W)=0.002. In an air atmosphere, the temperature was raised to 650° C., maintained for 6 hours, and naturally cooled, to obtain a secondary sintered cathode material Li[Li₀Ni_{0.4975}Mn_{0.2985}Co_{0.1791}Al_{0.0199}Ti_{0.003}W_{0.002}]@Nb_{0.002}La_{0.002}, which was recorded as FS-1.

### EXAMPLE 2 TO EXAMPLE 14

Example 2 to Example 14 were intended to illustrate the lithium-containing oxide cathode material prepared according to the present disclosure.

The lithium-containing oxide cathode material was prepared according to the same method as that of Example 1. Example 2 to Example 14 merely differed from Example 1 in the preparation processes of the precursor, primary sintered cathode material, and secondary sintered cathode material, as shown in Table 1.

TABLE 1

| | | | | |
|---|---|---|---|---|
| Example 1 | Example 2 | Example 3 | Example 4 | Example 5 |

Preparation process of precursor

| Nickel salt or | Nickel sulfate, | | Nickel sulfate, | | Nickel sulfate, | | Nickel sulfate, | | Nickel sulfate, | |
|---|---|---|---|---|---|---|---|---|---|---|
| manganese salt | manganese sulfate | | manganese sulfate | | manganese sulfate | | manganese sulfate | | manganese sulfate | |
| Ni/Mn ratio | 5:3 | | 6:2 | | 7.5:2.4 | | 8:1 | | 9:0.5 | |
| Additive M | Cobalt sulfate, | | Cobalt sulfate | | Ammonium | | Cobalt sulfate, | | Cobalt sulfate, | |
| | aluminum sulfate | | | | niobium oxalate | | ammonium tungstate | | aluminum sulfate | |
| Content of | Co/(Ni + Mn + | | Co/(Ni + Mn + | | Nb/(Ni + Mn + | | Co/(Ni + Mn + | | Co/(Ni + Mn + | |
| additive M | Co + Al) = 0.18; | | Co) = 0.2 | | Nb) = 0.1 | | Co + W) = 0.09; | | Co + Al) = 0.03; | |
| | Al/(Ni + Mn + | | | | | | W/(Ni + Mn + | | Al/(Ni + Mn + | |
| | Co + Al) = 0.02 | | | | | | Co + W) = 0.01 | | Co + Al) = 0.02 | |
| Precipitant | Sodium hydroxide | | Sodium hydroxide | | Sodium hydroxide | | Sodium hydroxide | | Sodium hydroxide | |
| Concentration | 6 | mol/L | 10 | mol/L | 2 | mol/L | 5 | mol/L | 5 | mol/L |
| of precipitant | | | | | | | | | | |
| Complexing | Ammonium | | Ammonium | | Ammonium | | Ammonium | | Ammonium | |
| agent | hydroxide | | hydroxide | | hydroxide | | hydroxide | | hydroxide | |
| Concentration of | 5 | mol/L | 8 | mol/L | 13 | mol/L | 5 | mol/L | 5 | mol/L |
| complexing agent | | | | | | | | | | |
| Reaction duration | 60 | h | 80 | h | 100 | h | 80 | h | 50 | h |
| Reaction | 50° | C. | 70° | C. | 55° | C. | 40° | C. | 60° | C. |
| temperature | | | | | | | | | | |
| pH | 11.6 | | 11.2 | | 12 | | 11.5 | | 12 | |
| Stirring speed | 600 | rmp | 800 | rpm | 500 | rpm | 700 | rpm | 600 | rpm |
| Solid content | 500 | g/L | 1,000 | g/L | 200 | g/L | 800 | g/L | 500 | g/L |

Preparation process of primary sintered cathode material

| Type of | Lithium carbonate | | Lithium carbonate | | Lithium hydroxide | | Lithium hydroxide | | Lithium hydroxide | |
|---|---|---|---|---|---|---|---|---|---|---|
| lithium salt | | | | | | | | | | |
| Type of | Titanium oxide, | | Boric acid, | | Magnesium oxide, | | Zirconium oxide, | | Rhenium oxide, | |
| additive M | tungsten oxide | | praseodymium | | yttrium oxide, | | strontium hydroxide | | samarium oxide | |
| | | | oxide | | cobalt oxide | | | | | |
| Amount of | Li:(Ni + Mn + | | Li:(Ni + Mn + Co + | | Li:(Ni + Mn + | | Li:(Ni + Mn + | | Li:(Ni + Mn + | |
| lithium salt | Co + Al + Ti + | | B + Pr) = 1.03 | | Nb + Mg + Y + | | Co + W + Zr + | | Co + Al + Re + | |
| | W) = 1.03 | | | | Co) = 1.05 | | Sr) = 1.05 | | Sm) = 1.02 | |
| Content of | Ti:(Ni + Mn + | | Ti:(Ni + Mn + Co + | | Mg:(Ni + Mn + | | Zr:(Ni + Mn + | | Re:(Ni + Mn + | |
| additive M | Co + Al + Ti + | | B + Pr) = 0.001; | | Nb + Mg + Y + | | Co + W + Zr + | | Co + Al + Re + | |
| | W) = 0.003; | | Pr:(Ni + Mn + Co + | | Co) = 0.005; | | Sr) = 0.005; | | Sm) = 0.002; | |
| | W:(Ni + Mn + | | B + Pr) = 0.002 | | Y:(Ni + Mn + | | Sr:(Ni + Mn + | | Sm:(Ni + Mn + | |
| | Co + Al + Ti + | | | | Nb + Mg + Y + | | Co + W + Zr + | | Co + Al + Re + | |
| | W) = 0.002 | | | | Co) = 0.005; | | Sr) = 0.005 | | Sm) = 0.002 | |
| | | | | | Co:(Ni + Mn + | | | | | |
| | | | | | Nb + Mg + Y + | | | | | |
| | | | | | Co) = 0.03 | | | | | |
| First sintering | Air | | Air | | Air | | Oxygen | | Oxygen | |
| atmosphere | | | | | | | | | | |
| First sintering | 920° | C. | 900° | C. | 850° | C. | 820° | C. | 790° | C. |
| temperature | | | | | | | | | | |
| First sintering | 10 | h | 15 | h | 10 | h | 12 | h | 20 | h |
| duration | | | | | | | | | | |

Preparation process of secondary sintered cathode material

| Type of | Niobium pentoxide, | | Aluminum fluoride, | | Boric acid, | | Aluminum | | Tungsten nitride, | |
|---|---|---|---|---|---|---|---|---|---|---|
| additive M′ | lanthanum trioxide | | titanium dioxide | | tungsten oxide, | | phosphate, | | aluminum fluoride | |
| | | | | | tantalum oxide | | ruthenium oxide | | | |
| Content of | Nb:(Ni + Mn + | | Al:(Ni + Mn + Co + | | B:(Ni + Mn + | | Al:(Ni + Mn + | | W:(Ni + Mn + | |
| additive M′ | Co + Al + Ti + | | B + Pr) = 0.003; | | Nb + Mg + Y + | | Co + W + Zr + | | Co + Al + Re + | |
| | W) = 0.002; | | Ti:(Ni + Mn + Co + | | Co) = 0.002; | | Sr) = 0.05; | | Sm) = 0.005; | |
| | La:(Ni + Mn + | | B + Pr) = 0.002 | | W:(Ni + Mn + | | Ru:(Ni + Mn + | | Al:(Ni + Mn + | |
| | Co + Al + Ti + | | | | Nb + Mg + Y + | | Co + W + Zr + | | Co + Al + Re + | |
| | W) = 0.002 | | | | Co) = 0.005; | | Sr) = 0.001 | | Sm) = 0.005 | |
| | | | | | Ta:(Ni + Mn + | | | | | |
| | | | | | Nb + Mg + Y + | | | | | |
| | | | | | Co) = 0.003 | | | | | |
| Second sintering | Air | | Air | | Air | | Oxygen | | Oxygen | |
| atmosphere | | | | | | | | | | |
| Second sintering | 650° | C. | 450° | C. | 500° | C. | 700° | C. | 700° | C. |
| temperature | | | | | | | | | | |
| Second sintering | 6 | h | 8 | h | 10 | h | 15 | h | 15 | h |
| duration | | | | | | | | | | |

| | | | | |
|---|---|---|---|---|
| Example 6 | Example 7 | Example 8 | Example 9 | Example 10 |

Preparation process of precursor

| Nickel salt or | Nickel sulfate, | | Nickel sulfate, | | Nickel sulfate, | | Nickel sulfate, | | Nickel sulfate, | |
|---|---|---|---|---|---|---|---|---|---|---|
| manganese salt | manganese sulfate | | manganese sulfate | | manganese sulfate | | manganese sulfate | | manganese sulfate | |
| Ni/Mn ratio | 9.5:0.2 | | 9.7:0.2 | | 3:6.5 | | 3.3:6.7 | | 2.5:7.5 | |
| Additive M | Cobalt | | Aluminum | | Aluminum | | / | | / | |
| | sulfate | | sulfate | | sulfate | | | | | |
| Content of | Co/(Ni + Mn + | | Al/(Ni + Mn + | | Al/(Ni + Mn + | | / | | / | |
| additive M | Co) = 0.03 | | Al) = 0.01 | | Al) = 0.05 | | | | | |
| Precipitant | Sodium | | Potassium | | Sodium | | Sodium | | Potassium | |
| | hydroxide | | hydroxide | | hydroxide | | hydroxide | | hydroxide | |
| Concentration | 6 | mol/L | 4 | mol/L | 4 | mol/L | 5 | mol/L | 6 | mol/L |
| of precipitant | | | | | | | | | | |
| Complexing | Ammonium | | Ammonium | | Ammonium | | Ammonium | | Ethylenediamine- | |
| agent | hydroxide | | hydroxide | | hydroxide | | hydroxide | | tetraacetic acid | |
| Concentration of | 5 | mol/L | 5 | mol/L | 4 | mol/L | 2 | mol/L | 1 | mol/L |
| complexing agent | | | | | | | | | | |
| Reaction duration | 25 | h | 80 | h | 40 | h | 60 | h | 100 | h |
| Reaction | 40° | C. | 50° | C. | 30° | C. | 40° | C. | 50° | C. |
| temperature | | | | | | | | | | |
| pH | 12.5 | | 12.0 | | 11.0 | | 11.2 | | 11.5 | |
| Stirring speed | 800 | rpm | 600 | rpm | 700 | rpm | 600 | rpm | 500 | rpm |
| Solid content | 200 | g/L | 600 | g/L | 300 | g/L | 350 | g/L | 500 | g/L |

Preparation process of primary sintered cathode material

| Type of | Lithium | | Lithium | | Lithium | | Lithium | | Lithium | |
|---|---|---|---|---|---|---|---|---|---|---|
| lithium salt | hydroxide | | hydroxide | | carbonate | | hydroxide | | hydroxide | |
| Type of | Yttrium oxide, | | Cobalt oxyhydroxide, | | Titanium oxide, | | Tungsten oxide, | | Cobalt hydroxide, | |
| additive M | zirconium oxide | | strontium hydroxide | | niobium oxide | | aluminum | | strontium hydroxide | |
| | | | | | | | oxyhydroxide | | | |
| Amount of | Li:(Ni + Mn + Co + | | Li:(Ni + Mn + Al + | | Li:(Ni + Mn + Al + | | Li:(Ni + Mn + | | Li:(Ni + Mn + | |
| lithium salt | Y + Zr) = 1.03 | | Co + Sr) = 1.03 | | Ti + Nb) = 1.5 | | W + Al) = 1.4 | | Co + Sr) = 1.3 | |
| Content of | Y:(Ni + Mn + Co + | | Co:(Ni + Mn + Al + | | Ti:(Li + Ni + Mn + | | W:(Li + Ni + Mn + | | Co:(Li + Ni + Mn + | |
| additive M | Y + Zr) = 0.01; | | Co + Sr) = 0.01; | | Al + Ti + Nb − 1) = | | W + Al − 1) = 0.01; | | Co + Sr − 1) = 0.01; | |
| | Zr:(Ni + Mn + Co + | | Sr:(Ni + Mn + Al + | | 0.005; | | Al:(Li + Ni + Mn + | | Sr:(Li + Ni + Mn + | |
| | Y + Zr) = 0.01 | | Co + Sr) = 0.002 | | Nb:(Li + Ni + Mn + | | W + Al − 1) = 0.005 | | Co + Sr − 1) = 0.005 | |
| | | | | | Al + Ti + Nb − 1) = | | | | | |
| | | | | | 0.005 | | | | | |
| First sintering | Oxygen | | Oxygen | | Air | | Air | | Air | |
| atmosphere | | | | | | | | | | |
| First sintering | 775° | C. | 750° | C. | 800° | C. | 810° | C. | 850° | C. |
| temperature | | | | | | | | | | |
| First sintering | 15 | h | 10 | h | 15 | h | 20 | h | 10 | h |
| duration | | | | | | | | | | |

Preparation process of secondary sintered cathode material

| Type of | Aluminum oxide, | | Scandium oxide, | | Aluminum fluoride, | | Lanthanum fluoride, | | Titanium phosphate, | |
|---|---|---|---|---|---|---|---|---|---|---|
| additive M′ | titanium phosphate | | lanthanum oxide | | zirconium oxide | | magnesium hydroxide | | aluminum phosphate | |
| Content of | Al:(Ni + Mn + Co + | | Sc:(Ni + Mn + Al + | | Al:(Li + Ni + Mn + | | La:(Li + Ni + Mn + | | Ti:(Li + Ni + Mn + | |
| additive M′ | Y + Zr) = 0.005; | | Co + Sr) = 0.002; | | Al + Ti + Nb − 1) = | | W + Al − 1) = 0.005; | | Co + Sr − 1) = 0.003; | |
| | Ti:(Ni + Mn + Co + | | La:(Ni + Mn + Al + | | 0.002; | | Mg:(Li + Ni + Mn + | | Al:(Li + Ni + Mn + | |
| | Y + Zr) = 0.003 | | Co + Sr) = 0.002 | | Zr:(Li + Ni + Mn + | | W + Al − 1) = 0.001 | | Co + Sr − 1) = 0.002 | |
| | | | | | Al + Ti + Nb − 1) = | | | | | |
| | | | | | 0.003 | | | | | |
| Second sintering | Oxygen | | Oxygen | | Air | | Air | | Air | |
| atmosphere | | | | | | | | | | |
| Second sintering | 600° | C. | 500° | C. | 700° | C. | 450° | C. | 700° | C. |
| temperature | | | | | | | | | | |
| Second sintering | 10 | h | 10 | h | 8 | h | 10 | h | 10 | h |
| duration | | | | | | | | | | |

| | | | |
|---|---|---|---|
| Example 11 | Example 12 | Example 13 | Example 14 |

Preparation process of precursor

| Nickel salt or | Nickel sulfate, | | Nickel sulfate, | | Manganese chloride, | | Nickel chloride, | |
|---|---|---|---|---|---|---|---|---|
| manganese salt | manganese sulfate | | manganese sulfate | | nickel nitrate | | manganese sulfate | |
| Ni/Mn ratio | 2:3 | | 1:4 | | 5.5:4 | | 2:8 | |
| Additive M | / | | Cobalt sulfate | | Aluminum sulfate | | / | |
| Content of | / | | Co/(Ni + Mn + | | Al/(Ni + Mn + | | / | |
| additive M | | | Co) = 1:6 | | Al) = 0.5 | | | |
| Precipitant | Sodium | | Sodium | | Sodium | | Sodium | |
| | hydroxide | | hydroxide | | hydroxide | | hydroxide | |
| Concentration | 10 | mol/L | 10 | mol/L | 5 | mol/L | 5 | mol/L |
| of precipitant | | | | | | | | |
| Complexing agent | Ammonium | | Ammonium | | Ammonium | | Ammonium | |
| | hydroxide | | sulfate | | hydroxide | | hydroxide | |
| Concentration of | 5 | mol/L | 1 | mol/L | 2 | mol/L | 2 | mol/L |
| complexing agent | | | | | | | | |
| Reaction duration | 75 | h | 80 | h | 60 | h | 80 | h |
| Reaction | 80° | C. | 50° | C. | 50° | C. | 80° | C. |
| temperature | | | | | | | | |
| pH | 12.0 | | 11.5 | | 11.2 | | 11.0 | |
| Stirring speed | 800 | rpm | 600 | rpm | 800 | rpm | 500 | rpm |
| Solid content | 600 | g/L | 500 | g/L | 500 | g/L | 400 | g/L |

Preparation process of primary sintered cathode material

| Type of | Lithium hydroxide | | Lithium carbonate | | Lithium hydroxide | | Lithium hydroxide | |
|---|---|---|---|---|---|---|---|---|
| lithium salt | | | | | | | | |
| Type of | Chromium oxide, | | Yttrium oxide, | | Magnesium hydroxide, | | Tantalum oxide, | |
| additive M | lanthanum oxide | | zirconium oxide | | titanium nitride | | niobium | |
| | | | | | | | oxyphosphate | |
| Amount of | Li:(Ni + Mn + | | Li:(Ni + Mn + Co + | | Li:(Ni + Mn + Al + | | Li:(Ni + Mn + | |
| lithium salt | Cr + La) = 1.6 | | Y + Zr) = 1.35 | | Mg + Ti) = 1.45 | | Ta + Nb) = 1.8 | |
| Content of | Cr:(Li + Ni + Mn + | | Y:(Li + Ni + Mn + | | Mg:(Li + Ni + Mn + | | Ta:(Li + Ni + Mn + | |
| additive M | Cr + La − 1) = 0.002; | | Co + Y + Zr − 1) = 0.005; | | Al + Mg + Ti − 1) = 0.01; | | Ta + Nb − 1) = 0.1; | |
| | La:(Li + Ni + Mn + | | Zr:(Li + Ni + Mn + | | Ti:(Li + Ni + Mn + | | Nb:(Li + Ni + Mn + | |
| | Cr + La − 1) = 0.002 | | Co + Y + Zr − 1) = 0.005 | | Al + Mg + Ti − 1) = 0.005 | | Ta + Nb − 1) = 0.1 | |
| First sintering | Oxygen | | Air | | Air | | Oxygen | |
| atmosphere | | | | | | | | |
| First sintering | 780° | C. | 800° | C. | 740° | C. | 900° | C. |
| temperature | | | | | | | | |
| First sintering | 15 | h | 10 | h | 15 | h | 20 | h |
| duration | | | | | | | | |

Preparation process of secondary sintered cathode material

| Type of | Boric acid, | | Aluminum oxide, | | Cobalt oxide, | | Molybdenum oxide, | |
|---|---|---|---|---|---|---|---|---|
| additive M′ | rhenium oxide | | tungsten oxide | | titanium dioxide | | tungsten sulfide | |
| Content of | B:(Li + Ni + Mn + | | Al:(Li + Ni + Mn + | | Co:(Li + Ni + Mn + | | Mo:(Li + Ni + Mn + | |
| additive M′ | Cr + La − 1) = 0.002; | | Co + Y + Zr − 1) = 0.005; | | Al + Mg + Ti − 1) = 0.01; | | Ta + Nb − 1) = 0.002; | |
| | Re:(Li + Ni + Mn + | | W:(Li + Ni + Mn + | | Ti:(Li + Ni + Mn + | | W:(Li + Ni + Mn + | |
| | Cr + La − 1) = 0.002 | | Co + Y + Zr − 1) = 0.005 | | Al + Mg + Ti − 1) = 0.005 | | Ta + Nb − 1) = 0.005 | |
| Second sintering | Oxygen | | Air | | Air | | Oxygen | |
| atmosphere | | | | | | | | |
| Second sintering | 350° | C. | 600° | C. | 650° | C. | 700° | C. |
| temperature | | | | | | | | |
| Second sintering | 20 | h | 6 | h | 6 | h | 10 | h |
| duration | | | | | | | | |

In Table 1, unless otherwise specified, all ratios and amounts were molar ratios.

### COMPARATIVE EXAMPLE 1

Comparative Example 1 adopted the same synthesis method and conditions as in Example 5. Comparative Example 1 merely differed from Example 5 in that, the first sintering temperature was adjusted to 600° C., and the cathode material obtained was recorded as D-1, as shown in Table 2.

### COMPARATIVE EXAMPLE 2

Comparative Example 2 adopted the same synthesis method and conditions as in Example 5. Comparative Example 2 merely differed from Example 5 in that, the first sintering temperature was adjusted to 900° C., and the cathode material obtained was recorded as D-2, as shown in Table 2.

### COMPARATIVE EXAMPLE 3

Comparative Example 3 adopted the same synthesis method and conditions as in Example 5. Comparative Example 3 merely differed from Example 5 in that, additives of rhenium oxide and samarium oxide were not added in the preparation process of the primary sintered cathode material, and the cathode material obtained was recorded as D-3, as shown in Table 2.

### COMPARATIVE EXAMPLE 4

Comparative Example 4 adopted the same synthesis method and conditions as in Example 5. Comparative Example 4 merely differed from Example 5 in that, additives of tungsten nitride and aluminum fluoride were not added in the preparation process of the secondary sintered cathode material, and the cathode material obtained was recorded as D-4, as shown in Table 2.

### COMPARATIVE EXAMPLE 5

Comparative Example 5 adopted the same synthesis method and conditions as in Example 9. Comparative Example 5 merely differed from Example 9 in that, the solid content was adjusted to 150 g/L in the preparation process of the precursor, and the cathode material obtained was recorded as D-5, as shown in Table 2.

### COMPARATIVE EXAMPLE 6

Comparative Example 6 adopted the same synthesis method and conditions as in Example 9. Comparative Example 6 merely differed from Example 9 in that, additives of tungsten oxide and aluminum hydroxide oxide were not added in the preparation process of the primary sintered cathode material, and the cathode material obtained was recorded as D-6, as shown in Table 2.

### COMPARATIVE EXAMPLE 7

Comparative Example 7 adopted the same synthesis method and conditions as in Example 9. Comparative Example 7 merely differed from Example 9 in that, the preparation process of the secondary sintered cathode material was omitted, and the cathode material obtained was recorded as D-7, as shown in Table 2.

TABLE 2

| | | | |
|---|---|---|---|
| Comparative | Comparative | Comparative | Comparative |
| Example 1 | Example 2 | Example 3 | Example 4 |

Preparation process of precursor

| Nickel salt or | Nickel sulfate, | | Nickel sulfate, | | Nickel sulfate, | | Nickel sulfate, | |
|---|---|---|---|---|---|---|---|---|
| manganese salt | manganese sulfate | | manganese sulfate | | manganese sulfate | | manganese sulfate | |
| Ni/Mn ratio | 9:0.5 | | 9:0.5 | | 9:0.5 | | 9:0.5 | |
| Additive M | Cobalt sulfate, | | Cobalt sulfate, | | Cobalt sulfate, | | Cobalt sulfate, | |
| | aluminum sulfate | | aluminum sulfate | | aluminum sulfate | | aluminum sulfate | |
| Content of | Co/(Ni + Mn + | | Co/(Ni + Mn + | | Co/(Ni + Mn + | | Co/(Ni + Mn + | |
| additive M | Co + Al) = 0.03; | | Co + Al) = 0.03; | | Co + Al) = 0.03; | | Co + Al) = 0.03; | |
| | Al/(Ni + Mn + | | Al/(Ni + Mn + | | Al/(Ni + Mn + | | Al/(Ni + Mn + | |
| | Co + Al) = 0.02 | | Co + Al) = 0.02 | | Co + Al) = 0.02 | | Co + Al) = 0.02 | |
| Precipitant | Sodium hydroxide | | Sodium hydroxide | | Sodium hydroxide | | Sodium hydroxide | |
| Concentration | 5 | mol/L | 5 | mol/L | 5 | mol/L | 5 | mol/L |
| of precipitant | | | | | | | | |
| Complexing | Ammonium | | Ammonium | | Ammonium | | Ammonium | |
| agent | hydroxide | | hydroxide | | hydroxide | | hydroxide | |
| Concentration of | 5 | mol/L | 5 | mol/L | 5 | mol/L | 5 | mol/L |
| complexing agent | | | | | | | | |
| Reaction | 50 | h | 50 | h | 50 | h | 50 | h |
| duration | | | | | | | | |
| Reaction | 60° | C. | 60° | C. | 60° | C. | 60° | C. |
| temperature | | | | | | | | |
| pH | 12.0 | | 12.0 | | 12.0 | | 12.0 | |
| Stirring speed | 600 | rpm | 600 | rpm | 600 | rpm | 600 | rpm |
| Solid content | 500 | g/L | 500 | g/L | 500 | g/L | 500 | g/L |

Preparation process of primary sintered cathode material

| Type of | Lithium hydroxide | | Lithium hydroxide | | Lithium hydroxide | | Lithium hydroxide | |
|---|---|---|---|---|---|---|---|---|
| lithium salt | | | | | | | | |
| Type of | Rhenium oxide, | | Rhenium oxide, | | / | | Rhenium oxide, | |
| additive M | samarium oxide | | samarium oxide | | | | samarium oxide | |
| Amount of | Li:(Ni + Mn + Co + | | Li:(Ni + Mn + Co + | | Li:(Ni + Mn + | | Li:(Ni + Mn + Co + | |
| lithium salt | Al + Re + Sm) = 1.02 | | Al + Re + Sm) = 1.02 | | Co + Al) = 1.02 | | Al + Re + Sm) = 1.02 | |
| Content of | Re:(Ni + Mn + Co + | | Re:(Ni + Mn + Co + | | / | | Re:(Ni + Mn + Co + | |
| additive M | Al + Re + Sm) = 0.002; | | Al + Re + Sm) = 0.002; | | | | Al + Re + Sm) = 0.002; | |
| | Sm:(Ni + Mn + Co + | | Sm:(Ni + Mn + Co + | | | | Sm:(Ni + Mn + Co + | |
| | Al + Re + Sm) = 0.002 | | Al + Re + Sm) = 0.002 | | | | Al + Re + Sm) = 0.002 | |
| First sintering | Oxygen | | Oxygen | | Oxygen | | Oxygen | |
| atmosphere | | | | | | | | |
| First sintering | 600° | C. | 900° | C. | 790° | C. | 790° | C. |
| temperature | | | | | | | | |
| First sintering | 20 | h | 20 | h | 20 | h | 20 | h |
| duration | | | | | | | | |

Preparation process of secondary sintered cathode material

| Type of | Tungsten nitride, | | Tungsten nitride, | | Tungsten nitride, | | / | |
|---|---|---|---|---|---|---|---|---|
| additive M′ | aluminum fluoride | | aluminum fluoride | | aluminum fluoride | | | |
| Content of | W:(Ni + Mn + Co + | | W:(Ni + Mn + Co + | | W:(Ni + Mn + Co + Al + | | / | |
| additive M′ | Al + Re + Sm) = 0.005; | | Al + Re + Sm) = 0.005; | | Re + Sm) = 0.005; | | | |
| | Al:(Ni + Mn + Co + | | Al:(Ni + Mn + Co + | | Al:(Ni + Mn + Co + Al + | | | |
| | Al + Re + Sm) = 0.005 | | Al + Re + Sm) = 0.005 | | Re + Sm) = 0.005 | | | |
| Second sintering | Oxygen | | Oxygen | | Oxygen | | Oxygen | |
| atmosphere | | | | | | | | |
| Second sintering | 700° | C. | 700° | C. | 700° | C. | 700° | C. |
| temperature | | | | | | | | |
| Second sintering | 5 | h | 15 | h | 15 | h | 15 | h |
| duration | | | | | | | | |

| | | |
|---|---|---|
| Comparative | Comparative | Comparative |
| Example 5 | Example 6 | Example 7 |

Preparation process of precursor

| | | | |
|---|---|---|---|
| Nickel salt or | Nickel sulfate, | Nickel sulfate, | Nickel sulfate, |
| manganese salt | manganese sulfate | manganese sulfate | manganese sulfate |
| Ni/Mn ratio | 3.3:6.7 | 3.3:6.7 | 3.3:6.7 |
| Additive M | / | / | / |
| Content of | / | / | / |
| additive M | | | |
| Precipitant | Sodium hydroxide | Sodium hydroxide | Sodium hydroxide |

| | | | | | | |
|---|---|---|---|---|---|---|
| Concentration | 5 | mol/L | 5 | mol/L | 5 | mol/L |
| of precipitant | | | | | | |

| | | | |
|---|---|---|---|
| Complexing | Ammonium hydroxide | Ammonium hydroxide | Ammonium hydroxide |
| agent | | | |

| | | | | | | |
|---|---|---|---|---|---|---|
| Concentration of | 2 | mol/L | 2 | mol/L | 2 | mol/L |
| complexing agent | | | | | | |
| Reaction duration | 30 | h | 60 | h | 60 | h |
| Reaction | 40° | C. | 40° | C. | 40° | C. |
| temperature | | | | | | |

| | | | |
|---|---|---|---|
| pH | 11.2 | 11.2 | 11.2 |

| | | | | | | |
|---|---|---|---|---|---|---|
| Stirring speed | 600 | rpm | 600 | rpm | 600 | rpm |
| Solid content | 150 | g/L | 350 | g/L | 350 | g/L |

Preparation process of primary sintered cathode material

| | | | |
|---|---|---|---|
| Type of | Lithium hydroxide | Lithium hydroxide | Lithium hydroxide |
| lithium salt | | | |
| Type of | Tungsten oxide, | / | Tungsten oxide, |
| additive M | aluminum hydroxide | | aluminum hydroxide |
| | oxide | | oxide |
| Amount of | Li:(Ni + Mn + W + | Li:(Ni + Mn) = 1.4 | Li:(Ni + Mn + |
| lithium salt | Al) = 1.4 | | W + Al) = 1.4 |
| Content of | W:(Li + Ni + Mn + | / | W:(Li + Ni + Mn + |
| additive M | W + Al − 1) = 0.01; | | W + Al − 1) = 0.01 |
| | Al:(Li + Ni + Mn + | | Al:(Li + Ni + Mn + |
| | W + Al − 1) = 0.005 | | W + Al − 1) = 0.005 |
| First sintering | Air | Air | Air |
| atmosphere | | | |

| | | | | | | |
|---|---|---|---|---|---|---|
| First sintering | 810° | C. | 810° | C. | 810° | C. |
| temperature | | | | | | |
| First sintering | 20 | h | 20 | h | 20 | h |
| duration | | | | | | |

Preparation process of secondary sintered cathode material

| | | | |
|---|---|---|---|
| Type of | Lanthanum fluoride, | Lanthanum fluoride, | / |
| additive M′ | magnesium hydroxide | magnesium hydroxide | |
| Content of | La:(Li + Ni + Mn + | La:(Li + Ni + Mn + | / |
| additive M′ | W + Al − 1) = 0.005; | W + Al − 1) = 0.005; | |
| | Mg:(Li + Ni + Mn + | Mg:(Li + Ni + Mn + | |
| | W + Al − 1) = 0.001 | W + Al − 1) = 0.001 | |
| Second sintering | Air | Air | / |
| atmosphere | | | |

| | | | | | |
|---|---|---|---|---|---|
| Second sintering | 450° | C. | 450° | C. | / |
| temperature | | | | | |
| Second sintering | 10 | h | 10 | h | / |
| duration | | | | | |

### TEST EXAMPLE 1

The performances of the precursors of the lithium-containing oxide cathode materials prepared in Example 1 to Example 14 and Comparative Example 1 to Comparative Example 7 were tested, and the results were shown in Table 3. The performances of the lithium-containing oxide cathode materials prepared in Example 1 to Example 14 and Comparative Example 1 to Comparative Example 7 were tested, and the results were shown in Table 4 and Table 5.

TABLE 3

| | | Δλ′ | Δλ′ |
|---|---|---|---|
| Precursor | Chemical formula | (P₅₀) | (P₁₀₀) |
| Example 1 | Ni_{0.5}Mn_{0.3}Co_{0.18}Al_{0.02}(OH)₂ | 49.8% | 38.9% |
| Example 2 | Ni_{0.6}Mn_{0.2}Co_{0.2}(OH)₂ | 43.7% | 37.6% |
| Example 3 | Ni_{0.75}Mn_{0.24}Nb_{0.01}(OH)₂ | 45.6% | 37.5% |
| Example 4 | Ni_{0.8}Mn_{0.1}Co_{0.09}W_{0.01}(OH)₂ | 44.2% | 32.4% |
| Example 5 | Ni_{0.9}Mn_{0.05}Co_{0.03}Al_{0.02}(OH)₂ | 45.4% | 30.4% |
| Example 6 | Ni_{0.95}Mn_{0.02}Co_{0.03}(OH)₂ | 45.2% | 33.3% |
| Example 7 | Ni_{0.97}Mn_{0.02}Al_{0.01}(OH)₂ | 45.6% | 32.6% |
| Example 8 | Ni_{0.3}Mn_{0.65}Al_{0.05}(OH)₂ | 53.2% | 42.4% |
| Example 9 | Ni_{0.33}Mn_{0.67}(OH)₂ | 51.6% | 42.6% |
| Example 10 | Ni_{0.25}Mn_{0.75}(OH)₂ | 60.6% | 50.0% |
| Example 11 | Ni_{0.4}Mn_{0.6}(OH)₂ | 48.3% | 38.3% |
| Example 12 | Ni_{0.167}Co_{0.167}Mn_{0.666}(OH)₂ | 67.8% | 57.2% |
| Example 13 | Ni_{0.4}Mn_{0.55}Al_{0.05}(OH)₂ | 48.8% | 38.6% |
| Example 14 | Ni_{0.2}Mn_{0.8}(OH)₂ | 67.6% | 57.5% |
| Comparative | Ni_{0.9}Mn_{0.05}Co_{0.03}Al_{0.02}(OH)₂ | 45.4% | 30.4% |
| Example 1 | | | |
| Comparative | Ni_{0.9}Mn_{0.05}Co_{0.03}Al_{0.02}(OH)₂ | 45.4% | 30.4% |
| Example 2 | | | |
| Comparative | Ni_{0.9}Mn_{0.05}Co_{0.03}Al_{0.02}(OH)₂ | 45.4% | 30.4% |
| Example 3 | | | |
| Comparative | Ni_{0.9}Mn_{0.05}Co_{0.03}Al_{0.02}(OH)₂ | 45.4% | 30.4% |
| Example 4 | | | |
| Comparative | Ni_{0.33}Mn_{0.67}(OH)₂ | 42.3% | 33.6% |
| Example 5 | | | |
| Comparative | Ni_{0.33}Mn_{0.67}(OH)₂ | 51.6% | 42.6% |
| Example 6 | | | |
| Comparative | Ni_{0.33}Mn_{0.67}(OH)₂ | 51.6% | 42.6% |
| Example 7 | | | |

TABLE 4

| Cathode | | | |
|---|---|---|---|
| material | Example 1 | Example 2 | Example 3 |
| Chemical | Li[Ni_{0.4975}Mn_{0.2985}Co_{0.1791}Al_{0.0199}Ti_{0.003} | Li[Ni_{0.5982}Mn_{0.1994}Co_{0.1994}B_{0.001} | Li[Ni_{0.72}Mn_{0.2304}Nb_{0.0096}Co_{0.03}Mg_{0.005} |
| formula | W_{0.002}]O₂@0.001Nb₂O₅•0.001La₂O₃ | Pr_{0.002}]O₂@0.003AlF₃•0.002TiO₂ | Y_{0.005}]O₂@0.001B₂O₃•0.005WO₃•0.0015Ta₂O₅ |
| Δλ(P₁₀₀) | 69.9% | 67.8% | 65.8% |
| Δλ(P₂₀₀) | 52.5% | 49.7% | 48.6% |
| Δλ(P₃₀₀) | 39.4% | 38.1% | 38% |
| Tap density | 2.4 | 2.7 | 2.1 |
| Pellet | 3.2 | 3.3 | 3.5 |
| density | | | |
| Li₂CO₃ | 0.1% | 0.2% | 0.15% |
| LiOH | 0.1% | 0.21% | 0.25% |
| FWHM₍₀₀₃₎ | 0.17 | 0.18 | 0.19 |
| FWHM₍₁₀₄₎ | 0.24 | 0.25 | 0.28 |
| S₍₀₀₃₎/S₍₁₀₄₎ | 1.3 | 1.26 | 1.22 |

| Cathode | | |
|---|---|---|
| material | Example 4 | Example 5 |
| Chemical | Li[Ni_{0.792}Mn_{0.099}Co_{0.0891}W_{0.0099}Zr_{0.005} | Li[Ni_{0.8964}Mn_{0.0498}Co_{0.0299}Al_{0.0199}Re_{0.002} |
| formula | Sr_{0.005}]O₂@0.05AlPO₄•0.001RuO₂ | Sm_{0.002}]O₂@0.0025W₂O₃•0.005AlF₃ |
| Δλ(P₁₀₀) | 65% | 66.2% |
| Δλ(P₂₀₀) | 48.2% | 48.5% |
| Δλ(P₃₀₀) | 37.7% | 37.8% |
| Tap density | 2.4 | 2.5 |
| Pellet | 3.3 | 3.7 |
| density | | |
| Li₂CO₃ | 0.18% | 0.26% |
| LiOH | 0.33% | 0.28% |
| FWHM₍₀₀₃₎ | 0.18 | 0.18 |
| FWHM₍₁₀₄₎ | 0.26 | 0.27 |
| S₍₀₀₃₎/S₍₁₀₄₎ | 1.3 | 1.35 |

| Cathode | | | |
|---|---|---|---|
| material | Example 6 | Example 7 | Example 8 |
| Chemical | Li[Ni_{0.931}Mn_{0.0196}Co_{0.0294}Y_{0.01} | Li[Ni_{0.9405}Mn_{0.0198}Al_{0.0297}Co_{0.01} | Li[Li_{0.2}Ni_{0.237}Mn_{0.5135}Al_{0.0395}Ti_{0.005} |
| formula | Zr_{0.01}]O₂@0.0025Al₂O₃•0.001Ti₃PO₄ | Sr_{0.002}]O₂@0.001Sc₂O₃•0.001La₂O₃ | Nb_{0.005}]O₂@0.002AlF₃•0.003ZrO₂ |
| Δλ(P₁₀₀) | 64.2% | 64.1% | 75.8% |
| Δλ(P₂₀₀) | 47.5% | 47.2% | 60.8% |
| Δλ(P₃₀₀) | 37.1% | 36.9% | 47.2% |
| Tap density | 2.4 | 1.8 | 1.7 |
| Pellet | 3.4 | 3.5 | 2.8 |
| density | | | |
| Li₂CO₃ | 0.45% | 0.26% | 0.16% |
| LiOH | 0.5% | 0.17% | 0.07% |
| FWHM₍₀₀₃₎ | 0.2 | 0.22 | 0.22 |
| FWHM₍₁₀₄₎ | 0.28 | 0.3 | 0.41 |
| S₍₀₀₃₎/S₍₁₀₄₎ | 1.36 | 1.38 | 1.22 |

| Cathode | | |
|---|---|---|
| material | Example 9 | Example 10 |
| Chemical | Li[Li_{0.167}Ni_{0.2699}Mn_{0.5481}W_{0.01} | Li[Li_{0.131}Ni_{0.2135}Mn_{0.6405}Co_{0.01} |
| formula | Al_{0.005}]O₂@0.005LaF₃•0.001MgO | Sr_{0.005}]O₂@0.001Ti₃PO₄•0.002AlPO₄ |
| Δλ(P₁₀₀) | 73.3% | 78.6% |
| Δλ(P₂₀₀) | 58.9% | 62.2% |
| Δλ(P₃₀₀) | 46.3% | 52.8% |
| Tap density | 1.8 | 1.7 |
| Pellet | 2.9 | 2.6 |
| density | | |
| Li₂CO₃ | 0.16% | 0.15% |
| LiOH | 0.14% | 0.12% |
| FWHM₍₀₀₃₎ | 0.2 | 0.16 |
| FWHM₍₁₀₄₎ | 0.38 | 0.37 |
| S₍₀₀₃₎/S₍₁₀₄₎ | 1.32 | 1.34 |

TABLE 5

| Cathode | Comparative |
|---|---|
| material | Example 1 |
| Chemical | Li[Ni_{0.8964}Mn_{0.0498}Co_{0.0299}Al_{0.0199}Re_{0.002}Sm_{0.002}]O₂@0.0025W₂O₃•0.005AlF₃ |
| formula | |
| Δλ(P₁₀₀) | 53.2% |
| Δλ(P₂₀₀) | 44.2% |
| Δλ(P₃₀₀) | 30.3% |
| Tap density | 2.2 g/cm³ |
| Pellet | 3.2 g/cm³ |
| density | |
| Li₂CO₃ | 0.59% |
| LiOH | 0.35% |
| FWHM₍₀₀₃₎ | 0.32 |
| FWHM₍₁₀₄₎ | 0.45 |
| S₍₀₀₃₎/S₍₁₀₄₎ | 0.92 |
| Cathode | Comparative |
| material | Example 2 |
| Chemical | Li[Ni_{0.8964}Mn_{0.0498}Co_{0.0299}Al_{0.0199}Re_{0.002}Sm_{0.002}]O₂@0.0025W₂O₃•0.005AlF₃ |
| formula | |
| Δλ(P₁₀₀) | 57.7% |
| Δλ(P₂₀₀) | 45.0% |
| Δλ(P₃₀₀) | 33.8% |
| Tap density | 2.4 g/cm³ |
| Pellet | 3.5 g/cm³ |
| density | |
| Li₂CO₃ | 0.36% |
| LiOH | 0.22% |
| FWHM₍₀₀₃₎ | 0.08 |
| FWHM₍₁₀₄₎ | 0.18 |
| S₍₀₀₃₎/S₍₁₀₄₎ | 1.05 |

| Cathode | Comparative | Comparative |
|---|---|---|
| material | Example 3 | Example 4 |
| Chemical | Li[Ni_{0.9}Mn_{0.05}Co_{0.03}Al_{0.02}]O₂@0.0025W₂O₃•0.005AlF₃ | Li[Ni_{0.8964}Mn_{0.0498}Co_{0.0299}Al_{0.0199}Re_{0.002}Sm_{0.002}]O₂ |
| formula | | |
| Δλ(P₁₀₀) | 55.5% | 50.1% |
| Δλ(P₂₀₀) | 44.7% | 41.5% |
| Δλ(P₃₀₀) | 32.6% | 29.9% |
| Tap density | 2.4 g/cm³ | 2.4 g/cm³ |
| Pellet | 3.5 g/cm³ | 3.5 g/cm³ |
| density | | |
| Li₂CO₃ | 0.42% | 0.52% |
| LiOH | 0.33% | 0.35% |
| FWHM₍₀₀₃₎ | 0.16 | 0.18 |
| FWHM₍₁₀₄₎ | 0.23 | 0.25 |
| S₍₀₀₃₎/S₍₁₀₄₎ | 1.65 | 1.43 |

| Cathode | Comparative | Comparative |
|---|---|---|
| material | Example 5 | Example 6 |
| Chemical | Li[Li_{0.167}Ni_{0.2699}Mn_{0.5481}W_{0.01}Al_{0.005}]O₂@0.005LaF₃•0.001MgO | Li[Li_{0.167}Ni_{0.2777}Mn_{0.5553}]O₂@0.005LaF_{3•}0.001MgO |
| formula | | |
| Δλ(P₁₀₀) | 55.6% | 66.3% |
| Δλ(P₂₀₀) | 48.2% | 51.6% |
| Δλ(P₃₀₀) | 38.6% | 40.3% |
| Tap density | 1.5 g/cm³ | 1.6 g/cm³ |
| Pellet | 2.5 g/cm³ | 2.6 g/cm³ |
| density | | |
| Li₂CO₃ | 0.32% | 0.46% |
| LiOH | 0.28% | 0.30% |
| FWHM₍₀₀₃₎ | 0.23 | 0.24 |
| FWHM₍₁₀₄₎ | 0.43 | 0.44 |
| S₍₀₀₃₎/S₍₁₀₄₎ | 1.71 | 1.1 |

| Cathode | Comparative |
|---|---|
| material | Example 7 |
| Chemical | Li[Li_{0.167}Ni_{0.2699}Mn_{0.5481}W_{0.01}Al_{0.005}]O₂ |
| formula | |
| Δλ(P₁₀₀) | 63.8% |
| Δλ(P₂₀₀) | 53.2% |
| Δλ(P₃₀₀) | 42.1% |
| Tap density | 1.6 g/cm³ |
| Pellet | 2.7 g/cm³ |
| density | |
| Li₂CO₃ | 0.42% |
| LiOH | 0.30% |
| FWHM₍₀₀₃₎ | 0.25 |
| FWHM₍₁₀₄₎ | 0.44 |
| S₍₀₀₃₎/S₍₁₀₄₎ | 1.15 |

### TEST EXAMPLE 2

The lithium-containing oxide cathode materials prepared in Example 1 to Example 14 and Comparative Example 1 to Comparative Example 7 were used as the positive electrode plate of the lithium-ion battery to prepare the lithium-ion battery. The performances of the lithium-ion batteries were tested, and the results were shown in Table 6.

TABLE 6

| Lithium-ion battery | Example 1 | Example 2 | Example 3 | Example 4 | Example 5 | Example 6 | Example 7 |
|---|---|---|---|---|---|---|---|
| Electrode density | 3.2 | 3.2 | 3.5 | 3.4 | 3.6 | 3.3 | 3.5 |
| (g/cm³) | | | | | | | |
| 0.1C discharge | 173.1 | 181.3 | 192.3 | 208.7 | 225.2 | 228.3 | 233.5 |
| capacity (mAh/g) | | | | | | | |
| 1C discharge | 158.6 | 167.1 | 176.5 | 192.2 | 214.3 | 216.2 | 218.5 |
| capacity | | | | | | | |
| (mAh/g) | | | | | | | |
| 1C capacity/0.1C | 91.6 | 92.2 | 91.8 | 92.1 | 95.1 | 94.7 | 93.6 |
| capacity (%) | | | | | | | |
| Capacity retention | 99.1 | 95.2 | 94.8 | 99.0 | 94.6 | 96.3 | 93.3 |
| rate % | | | | | | | |
| | Example 8 | Example 9 | Example 10 | Example 11 | Example 12 | Example 13 | Example 14 |
| Electrode density | 3.0 | 3.0 | 2.8 | 3.0 | 3.0 | 3.2 | 3.2 |
| (g/cm³) | | | | | | | |
| 0.1C discharge | 244.2 | 250.7 | 262.1 | 245.5 | 278.9 | 275.3 | 239.7 |
| capacity (mAh/g) | | | | | | | |
| 1C discharge | 211.3 | 214.5 | 225.0 | 216.2 | 240.3 | 236.7 | 202.2 |
| capacity (mAh/g) | | | | | | | |
| 1C capacity/0.1C | 86.5 | 85.6 | 85.8 | 88.1 | 86.2 | 86.0 | 84.4 |
| capacity (%) | | | | | | | |
| Capacity retention | 92.1 | 93.9 | 93.2 | 94.8 | 88.6 | 89.5 | 93.4 |
| rate (%) | | | | | | | |
| | Comparative | Comparative | Comparative | Comparative | Comparative | Comparative | Comparative |
| | Example 1 | Example 2 | Example 3 | Example 4 | Example 5 | Example 6 | Example 7 |
| Electrode | 3.2 | 3.6 | 3.5 | 3.3 | 2.8 | 2.8 | 2.9 |
| density | | | | | | | |
| (g/cm³) | | | | | | | |
| 0.1C | 216.9 | 208.3 | 221.7 | 214.3 | 240.9 | 241.9 | 233.0 |
| discharge | | | | | | | |
| capacity | | | | | | | |
| (mAh/g) | | | | | | | |
| 1C discharge | 190.9 | 188.5 | 200.2 | 194.4 | 203.3 | 198.8 | 190.3 |
| capacity | | | | | | | |
| (mAh/g) | | | | | | | |
| 1C | 88.0 | 90.5 | 90.3 | 90.7 | 84.4 | 82.2 | 81.7 |
| capacity/0.1C | | | | | | | |
| capacity (%) | | | | | | | |
| Capacity | 86.7 | 85.9 | 87.5 | 86.6 | 88.0 | 89.0 | 89.9 |
| retention rate | | | | | | | |
| (%) | | | | | | | |

In addition, in the present disclosure, FIG. 1 is a schematic comparison graph of charge-discharge curves of Example 5 and Comparative Example 1. As revealed in FIG. 1, by comparing the charge-discharge curves of Example 5 and Comparative Example 1, 0.1 C discharge capacity of the cathode material according to Example 5 (225.2 mAh/g) is higher than that of the cathode material D-1 obtained when the first sintering temperature is excessively low (600° C.) (216.9 mAh/g).

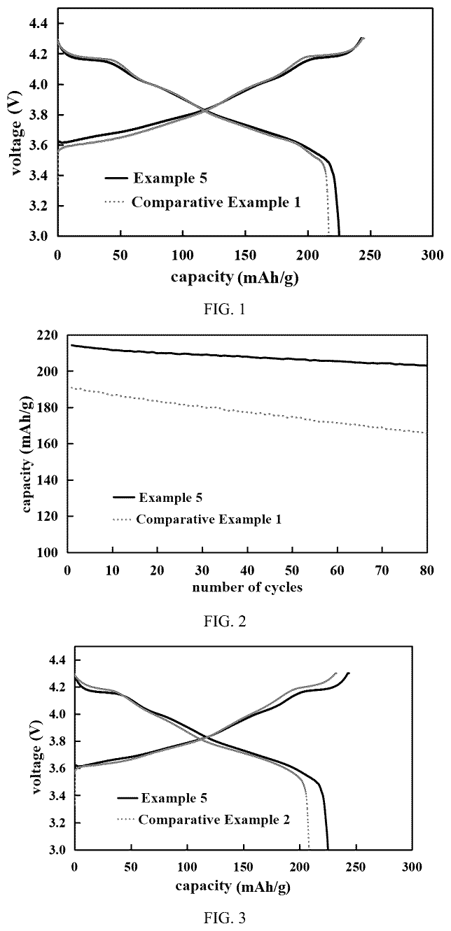

FIG. 2 is a schematic comparison graph of cycle performance of Example 5 and Comparative Example 1. As revealed in FIG. 2, by comparing the cycle performance of Example 5 and Comparative Example 1, a capacity retention rate according to Example 5 (94.6%) is significantly higher than that of the cathode material D-1 (86.7%). The reason therefor may be in the excessively low sintering temperature, and thus the growth of primary crystal grains is incomplete, resulting in a low compressive index and unstable structure, and thus exhibiting low capacity and cycle performance.

FIG. 3 is a schematic comparison graph of charge-discharge curves of Example 5 and Comparative Example 2. It can be seen from FIG. 3 by comparing the charge-discharge curves of Example 5 and Comparative Example 2 that 0.1 C discharge capacity of the cathode material according to Example 5 (225.2 mAh/g) is higher than that of the cathode material D-2 obtained when the first sintering temperature is excessively high (900° C.) (208.3 mAh/g).

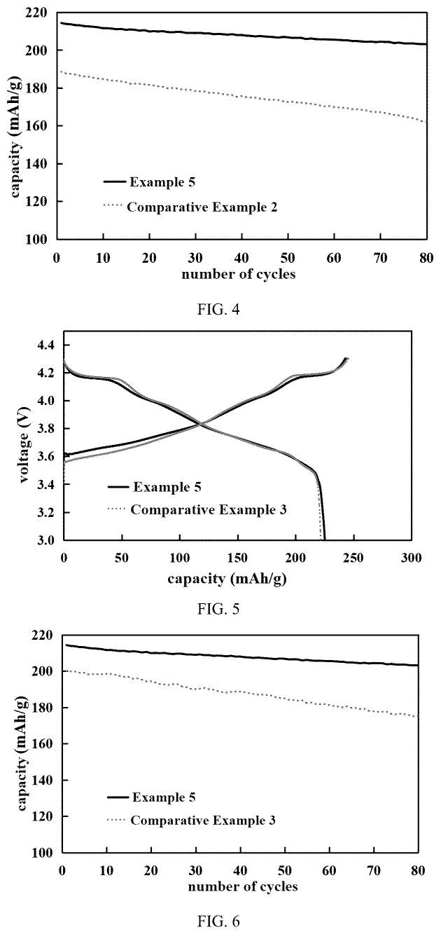

FIG. 4 is a schematic comparison graph of cycle performance of Example 5 and Comparative Example 2. It can be seen from FIG. 4 by comparing the cycle performance of Example 5 and Comparative Example 2 that capacity retention rate according to Example 5 (94.6%) is significantly higher than that of the cathode material provided by D-2 (85.9%). The reason may be in that the sintering temperature is excessively high, the growth of primary crystal grains is excessive, which may lead to a low compressive index and unstable structure, thereby causing low capacity and cycle performance.

FIG. 5 is a schematic comparison graph of charge-discharge curves of Example 5 and Comparative Example 3. It can be seen from FIG. 5 by comparing the charge-discharge curves of Example 5 and Comparative Example 3 that 0.1 C discharge capacity according to Example 5 (225.2 mAh/g) is higher than that of the cathode material D-3 obtained when additives of rhenium oxide and samarium oxide are not added in the first sintering (221.7 mAh/g).

FIG. 6 is a schematic comparison graph of cycle performance of Example 5 and Comparative Example 3. It can be seen from FIG. 6 by comparing the cycle performance of Example 5 and Comparative Example 3 that the capacity retention rate according to Example 5 (94.6%) is significantly higher than that of the cathode material D-3 (87.5%). The above shows that the addition of additives, i.e., rhenium oxide and samarium oxide, in the first sintering can improve the capacity and cycle performance of the material. The reason may be in that appropriate doping modification can improve micro-area structure of the material and form lithium-containing compounds on the surface of the particles or between the particles, which are all conducive to improving the compressive index of the material, thereby improving the electrochemical performance such as the capacity and cycle performance of the cathode material.

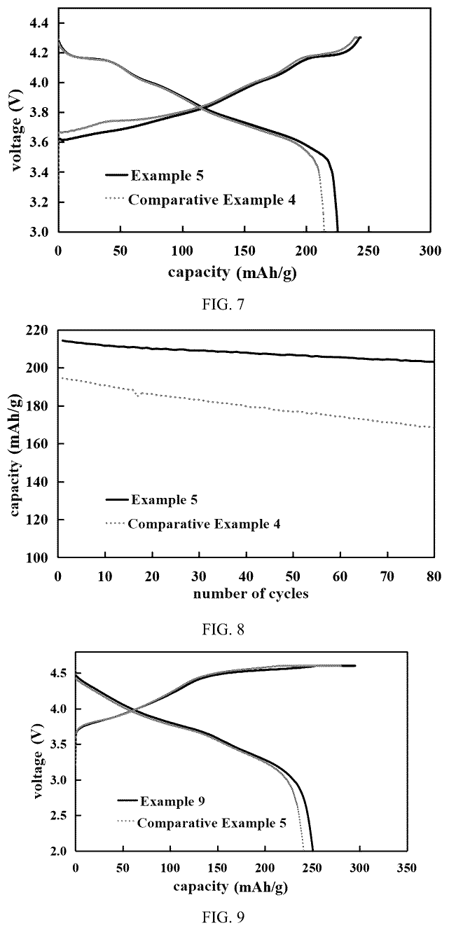

FIG. 7 is a schematic comparison graph of charge-discharge curves of Example 5 and Comparative Example 4. It can be seen from FIG. 7 by comparing the charge-discharge curves of Example 5 and Comparative Example 4 that 0.1 C discharge capacity according to Example 5 (225.2 mAh/g) is significantly higher than that of the cathode material D-4 obtained when additives of tungsten nitride and aluminum fluoride are not added in the second sintering (214.3 mAh/g).

FIG. 8 is a schematic comparison graph of cycle performance of Example 5 and Comparative Example 4. It can be seen from FIG. 8 by comparing the cycle performance of Example 5 and Comparative Example 4 that the capacity retention rate according to Example 5 (94.6%) is significantly higher than that of the cathode material D-4 (86.6%). The above indicate that the addition of additives, i.e., tungsten nitride and aluminum fluoride, in the second sintering can improve the capacity and cycle performance of the material. The reason may be in that a stable coating layer may be formed on the surface of the material, which improves surface micro-area structure of the material, reduces surface side reactions of the material, and also helps to improve the compressive index of the material, thereby improving the electrochemical performance such as the capacity and cycle performance of the cathode material.

FIG. 9 is a schematic comparison graph of charge-discharge curves of Example 9 and Comparative Example 5. It can be seen from FIG. 9 by comparing the charge-discharge curves of Example 9 and Comparative Example 5 that 0.1 C discharge capacity according to Example 9 (250.7 mAh/g) is significantly higher than that of the cathode material D-5 obtained when the solid content is reduced to 150 g/L in the preparation process of the precursor (240.9 mAh/g).

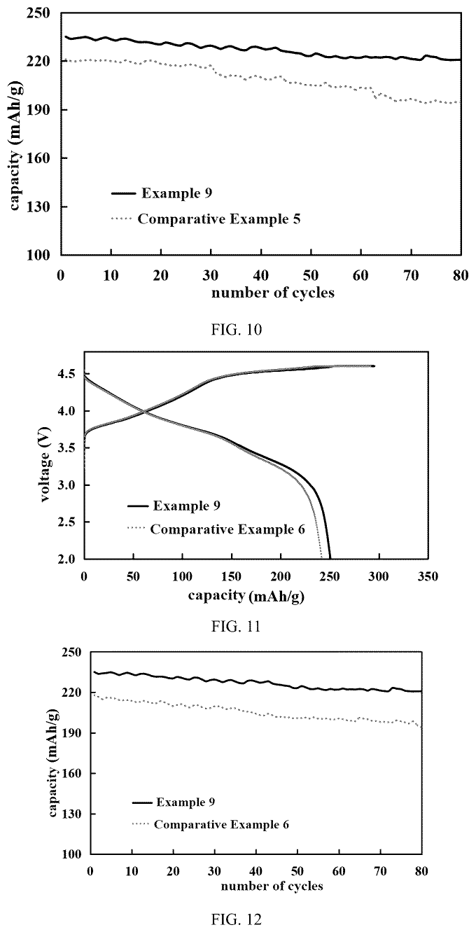

FIG. 10 is a schematic comparison graph of cycle performance of Example 9 and Comparative Example 5. It can be seen from FIG. 10 by comparing the cycle performance of Example 9 and Comparative Example 5 that the capacity retention rate according to Example 9 (93.9%) is significantly higher than that of the cathode material D-5 (88.0%). The reason may be in that low solid content may lead to poor crystallinity and compactness of the precursor, as well as changes in morphology and microstructure, thereby exhibiting a low compressive index and leading to deterioration of the electrochemical performance such as the capacity and cycle performance of the material.

FIG. 11 is a schematic comparison graph of charge-discharge curves of Example 9 and Comparative Example 6. It can be seen from FIG. 11 by comparing the charge-discharge curves of Example 9 and Comparative Example 6 that 0.1 C discharge capacity according to Example 9 (250.7 mAh/g) is significantly higher than that of the cathode material D-6 obtained when additives of tungsten oxide and aluminum hydroxide oxide are not added in the first sintering.

FIG. 12 is a schematic comparison graph of cycle performance of Example 9 and Comparative Example 6. It can be seen from FIG. 12 by comparing the cycle performance of Example 9 and Comparative Example 6 that the capacity retention rate according to Example 9 (93.9%) is significantly higher than that of the cathode material D-6 (89.0%). The above shows that the addition of additives of tungsten oxide and aluminum hydroxide oxide in the first sintering can improve the capacity and cycle performance of the material. The reason may be in that appropriate doping modification can improve the micro-area structure of the material and form lithium-containing compounds on the surface of the particles or between the particles, which are all conducive to improving the compressive index of the material, thereby improving the electrochemical performance such as the capacity and cycle performance of the cathode material.

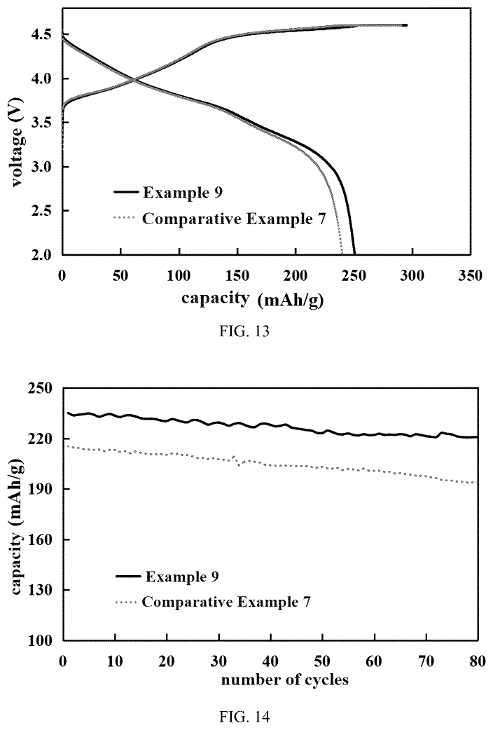

FIG. 13 is a schematic comparison graph of charge-discharge curves of Example 9 and Comparative Example 7. It can be seen from FIG. 13 by comparing the charge-discharge curves of Example 9 and Comparative Example 7 that 0.1 C discharge capacity according to Example 9 (250.7 mAh/g) is significantly higher than that of the cathode material D-7 obtained without the second sintering process.

FIG. 14 is a schematic comparison graph of cycle performance of Example 9 and Comparative Example 7. It can be seen from FIG. 14 by comparing the cycle performance of Example 9 and Comparative Example 7 that the capacity retention rate according to Example 9 (93.9%) is significantly higher than that of the cathode material D-7 (89.9%). The above indicates that the second sintering can effectively improve the capacity and cycle performance of the material. The reason may be in that the second sintering process can form a stable coating layer on the surface of the material and rearrange atoms on the surface of the material, thereby improving the surface micro-area structure of the material, reducing the surface side reactions of the material, and improving the compressive index of the material. In this way, the electrochemical performance such as the capacity and cycle performance of the cathode material can be improved.

The preferred embodiments of the present disclosure are described in detail above. However, the present disclosure is not limited thereto. Within the scope of technical conception of the present disclosure, a variety of simple variations may be made to the technical solutions of the present disclosure, including the combination of various technical features in any other suitable manner. These simple variations and combinations shall be regarded as the contents disclosed by the present disclosure, and all of them fall within the scope of protection of the present disclosure.

What is claimed is:

1. A lithium-containing oxide cathode material, wherein:
the cathode material has a compressive index Δλ(P₁₀₀) satisfying Δλ(P₁₀₀)≥60%+(y/x)×5%, where y/x is a molar ratio of Mn/Ni in the cathode material.

2. The cathode material according to claim 1, wherein:
the cathode material has a compressive index Δλ(P₂₀₀) satisfying Δλ(P₂₀₀)≥45%+(y/x)×5%; and/or
the cathode material has a compressive index Δλ(P₃₀₀) satisfying Δλ(P₃₀₀)≥35%+(y/x)×5%.

3. The lithium-containing oxide cathode material according to claim 1, wherein the lithium-containing oxide cathode material has a chemical formula represented by Formula (3):
Li[LiₐNiₓMn_{y}Mⱼ]O₂@M′, Formula (3), where:
0≤a≤0.3; 0.2<x<1; 0<y≤0.75; 0<j≤0.35; M is selected from at least one element of Al, Zr, Nb, Ti, Y, Sc, Cr, Co, W, Mg, La, Os, Pr, Re, Ru, Sr, Sm, Ta, and B; M′ is an oxide, phosphide, sulfide, fluoride, or chloride containing at least one element of Al, Zr, Nb, Ti, Y, Sc, Cr, Co, W, Mg, La, Os, Pr, Re, Ru, Sr, Sm, Ta, and B; and a molar content of cations in M′ is w, w satisfying 0<w/(a+x+y+j)≤0.1; and
preferably, 0.02≤a≤0.2; 0.3<x<0.9; 0.05<y≤0.68; 0<j≤0.3; 0.001<w/(a+x+y+j)≤0.02; M is selected from at least one element of Zr, Nb, Ti, Y, Sc, Cr, Co, W, Mg, La, Ta, and B; and M′ is oxide, phosphide, sulfide, or fluoride containing at least one element of Zr, Nb, Ti, Y, Sc, Cr, Co, W, Mg, La, Ta, and B.

4. The lithium-containing oxide cathode material according to claim 1, wherein:
the lithium-containing oxide cathode material has a pellet density of ≥2.8 g/cm³, preferably ≥3 g/cm³, and more preferably ≥3.2 g/cm³; and/or
the lithium-containing oxide cathode material has a tap density of ≥1.7 g/cm³, preferably ≥2 g/cm³, and more preferably ≥2.4 g/cm³; and/or
a content of surface soluble alkali of the lithium-containing oxide cathode material satisfies the following conditions: Li₂CO₃≤1 wt %, LiOH≤0.5 wt %; preferably, Li₂CO₃≤0.5 wt %, LiOH≤0.4 wt %; further preferably, Li₂CO₃≤0.3 wt %, LiOH≤0.3 wt %; and more preferably, Li₂CO₃≤0.2 wt %, LiOH≤0.2 wt %; and/or
a full width at half maximum FWHM₍₀₀₃₎ of (003) crystal plane and a full width at half maximum FWHM₍₁₀₄₎ of (104) crystal plane of the lithium-containing oxide cathode material obtained by X-Ray Diffraction, XRD, satisfy the following conditions: 0.10≤FWHM₍₀₀₃₎≤0.25, and preferably, 0.13≤FWHM₍₀₀₃₎≤0.22; and 0.20≤FWHM₍₁₀₄₎≤0.50, and preferably, 0.22≤FWHM₍₁₀₄₎≤0.42; and/or
a peak area S₍₀₀₃₎ of the (003) crystal plane and a peak area S₍₁₀₄₎ of the (104) crystal plane of the lithium-containing oxide cathode material obtained by XRD satisfy the following conditions: 1.1≤S₍₀₀₃₎/S₍₁₀₄₎≤1.8, and preferably, 1.2≤S₍₀₀₃₎/S₍₁₀₄₎≤1.6.

5. A precursor of a lithium-containing oxide cathode material, wherein:
the precursor has a compressive index Δλ′(P₅₀) satisfying Δλ′(P₅₀)≥35%+(v/u)×8%, where v/u is a molar ratio of Mn/Ni in the precursor.

6. The precursor according to claim 5, wherein the precursor has a compressive index Δλ′(P₁₀₀) satisfying Δλ′(P₁₀₀)≥25%+(v/u)×8%.

7. A preparation method of a lithium-containing oxide cathode material, the preparation method comprising:
S1: uniformly mixing a precursor having a chemical formula represented by Formula (1), a lithium source, and an optional additive containing element M₂, and performing a first sintering in an atmosphere furnace, to obtain a primary sintered material having a chemical formula represented by Formula (2); and
S2: uniformly mixing the primary sintered material with an additive containing element M′, and performing a second sintering on the mixed material in an atmosphere furnace, to obtain a lithium-containing metal oxide having a chemical formula represented by Formula (3),
NiᵤMnᵥM_{1γ}(OH)₂, Formula (1), where:
u+v+y=1, 0.2<u<1, 0<v≤0.75, 0≤γ≤0.35, and M₁ is selected from at least one element of Al, Zr, Nb, Ti, Y, Sc, Cr, Co, W, Mg, Na, La, Os, Pr, Re, Ru, Sr, Sm, Ta, and B;
Li[LiₐNiₓMn_{y}Mⱼ]O₂, Formula (2);
Li[LiₐNiₓMn_{y}Mⱼ]O₂@M′, Formula (3);
wherein in Formula (2) and Formula (3), a+x+y+j=1, 0≤a≤0.3, 0.2<x<1, 0<y≤0.75, 0<j≤0.35; and M comprises element M₁ in the precursor and element M₂ introduced during the first sintering, M₁ and M₂ being the same or different and being each selected from at least one element of Al, Zr, Nb, Ti, Y, Sc, Cr, Co, W, Mg, La, Os, Pr, Re, Ru, Sr, Sm, Ta, and B; and
wherein in Formula (3), M′ is oxide, phosphide, sulfide, fluoride, or chloride containing at least one element of Al, Zr, Nb, Ti, Y, Sc, Cr, Co, W, Mg, La, Os, Pr, Re, Ru, Sr, Sm, Ta, and B, and a molar content of cations in M′ is w, w satisfying 0<w/(a+x+y+j)≤0.1.

8. The preparation method according to claim 7, wherein:
when a molar ratio of Ni/Mn is greater than 1, satisfying x/y>1, a relationship between a sintering temperature T₁ of the first sintering and a content of Ni satisfies 550×(2−x)° C.≤T₁≤400×(3−x)° C., and a sintering duration of the first sintering ranges from 6 hours to 20 hours, and preferably, from 8 hours to 15 hours; and/or
when the molar ratio of Ni/Mn is smaller than or equal to 1, satisfying y/x>1, a relationship between a sintering temperature T₂ of the first sintering and a content of Mn satisfies 500×(1+y)° C.≤T₂≤650×(1+y)° C., and a sintering duration of the first sintering ranges from 6 hours to 20 hours, and preferably, from 8 hours to 15 hours; and/or
when x<0.5, the first sintering and the second sintering are performed in an air atmosphere; when 0.5≤x<0.6, the first sintering and the second sintering are performed in an air atmosphere or a mixture atmosphere of air and oxygen; and when x≥0.6, the first sintering and the second sintering are performed in an oxygen atmosphere or a mixture atmosphere of oxygen and air.

9. A lithium-containing oxide cathode material, prepared by the preparation method of the lithium-containing oxide cathode material according to claim 7.

10. A positive electrode plate, comprising at least 90 wt % of a lithium-containing oxide cathode material based on a total weight of the positive electrode plate, wherein:
the cathode material has a compressive index Δλ(P₁₀₀) satisfying Δλ(P₁₀₀)≥60%+(y/x)×5%, where y/x is a molar ratio of Mn/Ni in the cathode material.

11. The positive electrode plate according to claim 10, wherein the positive electrode plate has an electrode density of ≥2.8 g/cm³, preferably ≥3.2 g/cm³, and more preferably ≥3.5 g/cm³.

12. The positive electrode plate according to claim 10, wherein:
the cathode material has a compressive index Δλ(P₁₀₀) satisfying Δλ(P₁₀₀)≥60%+(y/x)×5%, where y/x is a molar ratio of Mn/Ni in the cathode material.

13. The positive electrode plate according to claim 10, wherein:
the cathode material has a compressive index Δλ(P₂₀₀) satisfying Δλ(P₂₀₀)≥45%+(y/x)×5%; and/or
the cathode material has a compressive index Δλ(P₃₀₀) satisfying Δλ(P₃₀₀)≥35%+(y/x)×5%.

14. The positive electrode plate according to claim 10, wherein the lithium-containing oxide cathode material has a chemical formula represented by Formula (3):
Li[LiₐNiₓMn_{y}Mⱼ]O₂@M′, Formula (3), where:
0≤a≤0.3; 0.2<x<1; 0<y≤0.75; 0<j≤0.35; M is selected from at least one element of Al, Zr, Nb, Ti, Y, Sc, Cr, Co, W, Mg, La, Os, Pr, Re, Ru, Sr, Sm, Ta, and B; M′ is an oxide, phosphide, sulfide, fluoride, or chloride containing at least one element of Al, Zr, Nb, Ti, Y, Sc, Cr, Co, W, Mg, La, Os, Pr, Re, Ru, Sr, Sm, Ta, and B; and a molar content of cations in M′ is w, w satisfying 0<w/(a+x+y+j)≤0.1; and
preferably, 0.02<a≤0.2; 0.3<x<0.9; 0.05<y≤0.68; 0<j≤0.3; 0.001<w/(a+x+y+j)≤0.02; M is selected from at least one element of Zr, Nb, Ti, Y, Sc, Cr, Co, W, Mg, La, Ta, and B; and M′ is oxide, phosphide, sulfide, or fluoride containing at least one element of Zr, Nb, Ti, Y, Sc, Cr, Co, W, Mg, La, Ta, and B.

15. The positive electrode plate according to claim 10, wherein:
the lithium-containing oxide cathode material has a pellet density of ≥2.8 g/cm³, preferably ≥3 g/cm³, and more preferably ≥3.2 g/cm³; and/or the lithium-containing oxide cathode material has a tap density of ≥1.7 g/cm³, preferably ≥2 g/cm³, and more preferably ≥2.4 g/cm³; and/or
a content of surface soluble alkali of the lithium-containing oxide cathode material satisfies the following conditions: Li₂CO₃≤1 wt %, LiOH≤0.5 wt %; preferably, Li₂CO₃≤0.5 wt %, LiOH≤0.4 wt %; further preferably, Li₂CO₃≤0.3 wt %, LiOH≤0.3 wt %; and more preferably, Li₂CO₃≤0.2 wt %, LiOH≤0.2 wt %; and/or
a full width at half maximum FWHM₍₀₀₃₎ of (003) crystal plane and a full width at half maximum FWHM₍₁₀₄₎ of (104) crystal plane of the lithium-containing oxide cathode material obtained by X-Ray Diffraction, XRD, satisfy the following conditions: 0.10≤FWHM₍₀₀₃₎≤0.25, and preferably, 0.13≤FWHM₍₀₀₃₎≤0.22; and 0.20≤FWHM₍₁₀₄₎≤0.50, and preferably, 0.22≤FWHM₍₁₀₄₎≤0.42; and/or
a peak area S₍₀₀₃₎ of the (003) crystal plane and a peak area S₍₁₀₄₎ of the (104) crystal plane of the lithium-containing oxide cathode material obtained by XRD satisfy the following conditions: 1.1≤S₍₀₀₃₎/S₍₁₀₄₎≤1.8, and preferably, 1.2≤S₍₀₀₃₎/S₍₁₀₄₎≤1.6.

16. A lithium-ion battery, comprising:
the positive electrode plate according to claim 10;
a negative electrode plate;
a separator disposed between the positive electrode plate and the negative electrode plate; and
an electrolyte.
